(19) United States
(12) Patent Application Publication
(10) Pub. No.: US 2011/0247655 A1
(43) Pub. Date: Oct. 13, 2011

(54) SYSTEMS AND METHODS FOR SANITIZING PRODUCE IN AN ACIDIC BATH

(75) Inventors: David K. Lewis, Salinas, CA (US); Kai Lai Grace Ho, Salinas, CA (US); Diego A. Luzuriaga, Weston, FL (US); Tim Filipowski, Newnan, GA (US)

(73) Assignee: Fresh Express, Inc., Salinas, CA (US)

(21) Appl. No.: 13/037,191

(22) Filed: Feb. 28, 2011

Related U.S. Application Data
(60) Provisional application No. 61/308,870, filed on Feb. 26, 2010.

(51) Int. Cl. B08B 3/10; B08B 3/04

(52) U.S. Cl. 134/18; 134/25.3; 134/56 R

(57) ABSTRACT

Methods and systems are disclosed for treating a produce item with a treatment solution that includes water and a first and second treatment acid. The disclosed methods and systems may be particularly beneficial when used to sanitize the produce item of pathogens and/or to maintain the quality of the produce item. A disclosed treatment method includes measuring an amount of water; measuring an amount of a first treatment acid; measuring an amount of a second treatment acid; mixing the water, the first treatment acid, and the second treatment acid to form a treatment-solution concentrate; diluting a quantity of the treatment-solution concentrate to form a treatment solution; and contacting an exterior surface of the produce item with a quantity of the treatment solution.

### CROSS-REFERENCES TO RELATED APPLICATIONS

This application claims the benefit of U.S. Provisional Application No. 61/308,870, entitled “Systems and Methods for Sanitizing Produce in an Acidic Bath,” filed Feb. 26, 2010 (Attorney Doket No. 18189K-019900US), the entire disclosure of which is hereby incorporated herein by reference. The present application is related to U.S. Patent Publication No. 2009/0324789, entitled “Peracid and 2-Hydroxy Organic Acid Compositions and Methods For Treating Produce,” filed Jun. 24, 2009 (Attorney Docket No. 18189K-015310US); PCT/US2010/61354, entitled “Peracid and 2-Hydroxy Organic Acid Compositions and Methods For Treating Items,” filed Dec. 20, 2010 (Attorney Docket No. 18189K-019410PC); PCT/US2010/61361, entitled “Peracid and 2-Hydroxy Organic Acid Compositions and Methods For Sanitation and Disease Prevention,” filed Dec. 20, 2010 (Attorney Docket No. 18189K-019510PC); and PCT/US2010/61366, entitled “Peracid and 2-Hydroxy Organic Acid Compositions and Methods For Treating Items in the Food Industry and Agriculture,” filed Dec. 20, 2010 (Attorney Docket No. 18189K-019610PC); the full disclosures of which are hereby incorporated herein by reference.

### BACKGROUND

The present invention relates generally to the sanitation of items, and more particularly to systems and methods for sanitizing a food item, such as produce, via the application of an acid solution to the food item.

Food-borne pathogens can cause serious illness and, in some instances, death. Even though the United States has one of the safest food supplies in the world, there are still millions of cases of food-borne illnesses each year. Common food-borne pathogens include bacillus cereus, campylobacter jejuni, clostridium botulinum, clostridium perfringens, cryptosporidium parvum, Escherichia coli 0157:H7, giardia lamblia, hepatitis A, listeria monocytogenes, norovirus, salmonellosis, staphylococcus, shigella, toxoplasma gondii, vibrio, and yersiniosis. Unpleasant symptoms associated with this list of common food-borne pathogens include abdominal cramps, nausea, vomiting, diarrhea, headache, fatigue, dry mouth, double vision, muscle paralysis, respiratory failure, dehydration, loss of appetite, hemorrhagic colitis, hemolytic uremic syndrome, fever, malaise, abdominal discomfort, meningitis, sepsticemia, miscarriage, abdominal pain, chills, prostration, bleeding, swollen lymph glands, muscle aches, and entercolitis.

Existing methods for removing or reducing pathogens from the surface of produce such as fruits and vegetables may not adequately control pathogens that have the potential to cause disease and/or spoil produce. Accordingly, there is a need for new and improved systems and methods for sanitizing produce of pathogens.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Systems and methods for sanitizing and/or maintaining the quality of produce (e.g., fruits and vegetables) are disclosed. The disclosed systems and methods may be particularly useful when used in conjunction with a treatment solution disclosed in U.S. Patent Publication No. 2009/0324789, entitled “Peracid and 2-Hydroxy Organic Acid Compositions and Methods For Treating Produce;” PCT/US2010/61354, entitled “Peracid and 2-Hydroxy Organic Acid Compositions and Methods For Treating Items;” PCT/US2010/61361, entitled “Peracid and 2-Hydroxy Organic Acid Compositions and Methods For Sanitation and Disease Prevention;” and PCT/2010/61366, entitled “Peracid and 2-Hydroxy Organic Acid Compositions and Methods For Treating Items in the Food Industry and Agriculture;” all of which are incorporate by reference above.

In many embodiments, a treatment-solution concentrate is prepared and supplied to one or more produce treatment lines for use in sanitizing produce. The treatment-solution concentrate is diluted to a suitable level before the resulting treatment solution is used in treating the produce. Provisions are disclosed for purging the treatment-solution concentrate and/or the resulting treatment solution from the system and for raising the pH of the treatment-solution concentrate and/or the resulting treatment solution to a level acceptable by most municipal waste water treatment facilities (e.g., a minimum pH of 5.0) before discharging the resulting waste water to a waste water treatment facility.

The disclosed systems and methods provide for the sanitation of produce and/or the maintenance of the quality of produce in an efficient, accurately controlled, cost-effective, and maintenance-friendly manner. The disclosed batch preparation of treatment-solution concentrate provides a fast way of preparing a quantity of accurately-controlled treatment-solution concentrate. The prepared batches can be sized and timed to match the usage rate of the treatment-solution concentrate. A holding tank for the prepared treatment-solution concentrate can be used to provide a storage receptacle for prepared batches of the treatment-solution concentrate from which the treatment-solution concentrate can be supplied to one or more produce treatment lines. In many embodiments, load cells coupled with a mixing tank provide a means to monitor and control the amount of the constituent elements of the treatment-solution concentrate (e.g., water, lactic acid (LA), peracetic acid (PAA)) in a particular batch, thereby providing for a quick assembly of a batch of the treatment-solution concentrate. In many embodiments, analysis of a sample of treatment-solution concentrate from a particular batch can be used to determine how much additional water, lactic acid, and/or peracetic acid to add to fine tune the concentrations of the constituent elements in the batch. For example, lab testing and/or electronic monitoring of a sample from the batch can be used to determine current concentrations of the lactic acid and/or peracetic acid in the batch, thereby allowing a determination of how much additional water, lactic acid, and/or peracetic acid to add to the batch to achieve desired concentration levels. The disclosed purging and waste-water treatment provide the ability to remove unused treatment-solution concentrate and/or treatment solution from the system, as well as a cost effective way of disposing of the resulting waste water.

Thus, in a first aspect, a method is disclosed for treating a produce item. The treatment method includes measuring an amount of water; measuring an amount of a first treatment acid; measuring an amount of a second treatment acid; mixing the measured amounts of the water, the first treatment acid, and the second treatment acid to form a treatment-solution concentrate; diluting a quantity of the treatment-solution concentrate to form a treatment solution; and contacting an exterior surface of the produce item with a quantity of the treatment solution.

The mixing of the measured amounts of the water, the first treatment acid, and second treatment acid can be accomplished in various ways. The mixing can, for example, be accomplished via a mixing tank. Each of the measured amounts of the water, the first treatment acid, and the second treatment acid can be determined, for example, by weighing the mixing tank and contents of the mixing tank prior to adding the measured amount and at least one of during or after the addition of the measured amount to the mixing tank.

Once mixed, the resulting treatment-solution concentrate can be transferred to a holding tank prior to distribution to a treatment line where the treatment-solution concentrate is diluted to form a treatment solution that is used to treat the produce. For example, a re-circulating loop can be used to circulate treatment-solution concentrate from the holding tank to at least one distribution outlet in controlled fluid communication with a treatment line, with undistributed treatment-solution concentrate circulated back to the holding tank.

A sample of the treatment-solution concentrate can be analyzed to determine a concentration of the first treatment acid and/or the second treatment acid in the sample. The sample can be physically extracted and analyzed in a laboratory when, for example, the first treatment acid is lactic acid (LA) and/or the second treatment acid is peroxyacetic acid (PAA). The sample can be analyzed by a suitable commercially available measurement device when, for example, the second treatment acid is peroxyacetic acid.

The concentrations of the first and second treatment acids in the treatment solution can be controlled within suitable ranges. For example, when the first treatment acid is lactic acid and the second treatment acid is peroxyacetic acid, the concentration of the lactic acid in the treatment solution is preferably controlled to be between 840 parts per million (ppm) and 10,000 ppm, and the concentration of the peroxyacetic acid in the treatment solution is preferably controlled to be between 10 ppm and 80 ppm. More preferably, the concentration of the lactic acid in the treatment solution is controlled to be between 1300 ppm and 5600 ppm and the concentration of the peroxyacetic acid in the treatment solution is controlled to be between 65 ppm and 75 ppm.

The treatment-solution concentrate can be transferred to a treatment apparatus at a suitable rate to maintain suitable concentrations of the treatment acids in the treatment solution. For example, the rate by which the treatment-solution concentrate is transferred to the apparatus can be set based on a produce item type treated via the treatment apparatus, a rate by which the produce item is treated via the treatment apparatus, and a rate of rinse water employed during the treating of the produce item. The rate by which the treatment-solution concentrate is transferred to the apparatus can also be adjusted in response to a measured treatment acid concentration in the treatment solution, for example, in response to a measured concentration of PAA and/or LA in the treatment solution where the first treatment acid includes LA and the second treatment acid includes PAA.

The treatment-solution in the treatment apparatus can be neutralized and discharged to, for example, a waste water treatment facility. For example, a neutralizing agent can be added to a quantity of the treatment solution in a treatment line to form a neutralized treatment solution having a pH higher than the treatment solution prior to neutralization. And the neutralized treatment solution can be discharged from the treatment line.

Quantities (e.g., unused quantities) of the treatment-solution concentrate can be neutralized and discharged to, for example, a waste water treatment facility. For example, a quantity of the treatment-solution concentrate can be transferred to a purge tank. A neutralizing agent (e.g., caustic soda (NaOH)) can be added to the purge tank to form a neutralized treatment-solution concentrate having a pH higher than the quantity of the treatment-solution concentrate prior to neutralization. And the neutralized treatment-solution concentrate can be discharged from the purge tank.

In another aspect, a system is disclosed for treating a produce item. The treatment system includes a mixing subsystem and a treatment subsystem in controlled fluid communication with the mixing subsystem and configured to dilute a quantity of a treatment-solution concentrate received from the mixing subsystem to form a treatment solution and contact an exterior surface of the produce item with a quantity of the treatment solution. The mixing subsystem prepares the treatment-solution concentrate by mixing a measured amount of water, a measured amount of a first treatment acid, and a measured amount of a second treatment acid.

The mixing subsystem can include a mixing tank, a water source in fluid communication with the mixing tank through a water inlet device (e.g., a controllable valve, a metering pump) to transfer a measured amount of water to the mixing tank, a first container holding a first treatment acid and in fluid communication with the mixing tank through a first pump to transfer a measured amount of the first treatment acid from the first container to the mixing tank, and a second container holding a second treatment acid and in fluid communication with the mixing tank through a second pump to transfer a measured amount of the second treatment acid from the first container to the mixing tank. The mixing tank mixes the measured amounts of water, the first treatment acid, and the second treatment acid to form the treatment-solution concentrate.

The mixing subsystem can use at least one weight measuring device to determine the measured amount of the water, the measured amount of the first treatment acid, and the measured amount of the second treatment acid. Each of the measured amounts can be determined by weighing the mixing tank and the contents of the mixing tank prior to adding the measured amount and at least one of during or after the addition of the measured amount to the mixing tank.

The system can include a holding tank for the treatment-solution concentrate. The holding tank can be in controlled fluid communication with the mixing tank to receive a quantity of the treatment-solution concentrate from the mixing tank.

The system can include a re-circulation loop through which a quantity of the treatment-solution concentrate received from the holding tank is circulated back to the holding tank. The treatment subsystem can receive the quantity of the treatment-solution concentrate that is diluted via an outlet in the re-circulating loop.

The system can include a neutralization subsystem to neutralize the treatment-solution concentrate and/or the treatment solution prior to discharge to a waste water treatment facility. For example, the neutralization subsystem can be configured to add a neutralizing agent to the treatment solution and/or the treatment-solution concentrate to form a neutralized solution. The neutralization subsystem can include, for example, a purge tank to receive a quantity of the treatment solution and/or the treatment-solution concentrate and to receive the added neutralizing agent. The neutralized solution can then be discharged from the neutralization subsystem.

The concentrations of the first and second treatment acids in the treatment solution can be controlled within suitable ranges. For example, when the first treatment acid is lactic acid and the second treatment acid is peroxyacetic acid, the concentration of the lactic acid in the treatment solution is preferably controlled to be between 840 parts per million (ppm) and 10,000 ppm, and the concentration of the peroxyacetic acid in the treatment solution is preferably controlled to be between 10 ppm and 80 ppm. More preferably, the concentration of the lactic acid in the treatment solution is controlled to be between 1300 ppm and 5600 ppm and the concentration of the peroxyacetic acid in the treatment solution is controlled to be between 65 ppm and 75 ppm.

The treatment-solution concentrate can be transferred to the treatment subsystem at a suitable rate to maintain suitable concentrations of the treatment acids in the treatment solution. For example, the rate by which the treatment-solution concentrate is transferred to the treatment subsystem can be set based on a produce item type treated via the treatment subsystem, a rate by which the produce item is treated via the treatment subsystem, and a rate of rinse water employed during the treating of the produce item. The rate by which the treatment-solution concentrate is transferred to the treatment subsystem can also be adjusted in response to a measured treatment acid concentration in the treatment solution, for example, in response to a measured concentration of PAA and/or LA in the treatment solution where the first treatment acid includes LA and the second treatment acid includes PAA.

In another aspect, an apparatus is disclosed for treating a produce item. The treatment apparatus includes a fluid circuit circulating a treatment solution, a washing station contacting an exterior surface of the produce item with the treatment solution, a first controllable inlet device to control transfer of a treatment-solution concentrate into the circulating treatment solution, and a second controllable inlet device to control the transfer of water into the circulating treatment solution. The first and second inlet devices are controlled to regulate the concentration of the treatment-solution concentrate in the circulating treatment solution.

The concentrations of the first and second treatment acids in the treatment solution can be controlled within suitable ranges. For example, when the first treatment acid is lactic acid and the second treatment acid is peroxyacetic acid, the concentration of the lactic acid in the treatment solution is preferably controlled to be between 840 parts per million (ppm) and 10,000 ppm, and the concentration of the peroxyacetic acid in the treatment solution is preferably controlled to be between 10 ppm and 80 ppm. More preferably, the concentration of the lactic acid in the treatment solution is controlled to be between 1300 ppm and 5600 ppm and the concentration of the peroxyacetic acid in the treatment solution is controlled to be between 65 ppm and 75 ppm.

The treatment-solution concentrate can be transferred to a treatment apparatus at a suitable rate to maintain suitable concentrations of the treatment acids in the treatment solution. For example, the rate by which the treatment-solution concentrate is transferred to the apparatus can be set based on a produce item type treated via the treatment apparatus, a rate by which the produce item is treated via the treatment apparatus, and a rate of rinse water employed during the treating of the produce item. The rate by which the treatment-solution concentrate is transferred to the apparatus can also be adjusted in response to a measured treatment acid concentration in the treatment solution, for example, in response to a measured concentration of PAA and/or LA in the treatment solution where the first treatment acid includes LA and the second treatment acid includes PAA.

For a fuller understanding of the nature and advantages of the present invention, reference should be made to the ensuing detailed description and accompanying drawings.

### BRIEF DESCRIPTION OF THE DRAWINGS

FIG. 1 is a flow chart illustrating the preparation and distribution of a treatment-solution concentrate that includes lactic acid and peroxyacetic acid in a produce sanitation system, in accordance with many embodiments.

FIG. 2 diagrammatically illustrates a mixing subsystem that prepares and distributes a treatment-solution concentrate comprising water, lactic acid, and peroxyacetic acid, in accordance with many embodiments.

FIG. 3a is a front-view illustration of a batch mixing-tower platform assembly in accordance with the mixing subsystem of FIG. 2.

FIG. 3b is a rear sectional view illustration of the batch mixing-tower platform assembly of FIG. 3a.

FIG. 3c is a right-side view illustration of the batch mixing-tower platform assembly of FIG. 3a.

FIG. 3d is a rear-side sectional-view illustration of the batch mixing-tower platform assembly of FIG. 3a.

FIG. 3e is a plan-view illustration of the batch mixing-tower platform assembly of FIG. 3a.

FIG. 3f illustrates section A-A of the batch mixing-tower platform assembly of FIG. 3a.

FIGS. 4a and 4b illustrates a mixing subsystem with two mixing tanks and associated holding tanks, the mixing subsystem configured to prepare a treatment-solution concentrate comprising water, lactic acid, and peracetic acid, in accordance with many embodiments.

FIG. 5 is a perspective view of a batch mixing-tower platform in accordance with the mixing subsystem of FIGS. 4a and 4b.

FIGS. 6a through 6e show a flow chart illustrating a mixing algorithm in accordance with the mixing subsystem of FIG. 2.

FIGS. 7a through 7m illustrate a user interface in accordance with the mixing subsystem of FIG. 2.

FIG. 8 illustrates an example produce treatment line that receives a treatment-solution concentrate and sanitizes produce using diluted treatment-solution concentrate, in accordance with many embodiments.

FIG. 9 illustrates another example produce treatment line that receives a treatment-solution concentrate and sanitizes produce using diluted treatment-solution concentrate, in accordance with many embodiments.

FIG. 10 illustrates another example produce treatment line that receives a treatment-solution concentrate and sanitizes produce using diluted treatment-solution concentrate, in accordance with many embodiments.

FIG. 11 illustrates another example produce treatment line that receives a treatment-solution concentrate and sanitizes produce using diluted treatment-solution concentrate, in accordance with many embodiments.

FIGS. 12a and 12b illustrate another example produce treatment line that receives a treatment-solution concentrate and sanitizes produce using diluted treatment-solution concentrate, in accordance with many embodiments.

FIG. 13 illustrates a neutralization subsystem operable to add a neutralizing agent to a treatment solution and/or a treatment-solution concentrate so as to form a neutralized solution suitable to be discharged to a waste water treatment facility, in accordance with many embodiments.

FIG. 14a illustrates a consumption rate of lactic acid in 600 gallons of treatment solution during treatment of diced Romaine lettuce, in accordance with many embodiments.

FIG. 14b illustrates a consumption rate of peroxyacetic acid in 600 gallons of treatment solution during treatment of diced Romaine lettuce, in accordance with many embodiments.

FIG. 14c illustrates a consumption rate of peroxyacetic acid and an associated change in pH in the treatment solution during the treatment of chopped Romaine lettuce, in accordance with many embodiments.

### DETAILED DESCRIPTION

In the following description, various embodiments of the present invention will be described. For purposes of explanation, specific configurations and details are set forth in order to provide a thorough understanding of the embodiments. The present invention can, however, be practiced without the specific details. Furthermore, well-known features may be omitted or simplified in order not to obscure the embodiment being described.

Sanitation System Top-Level Configuration

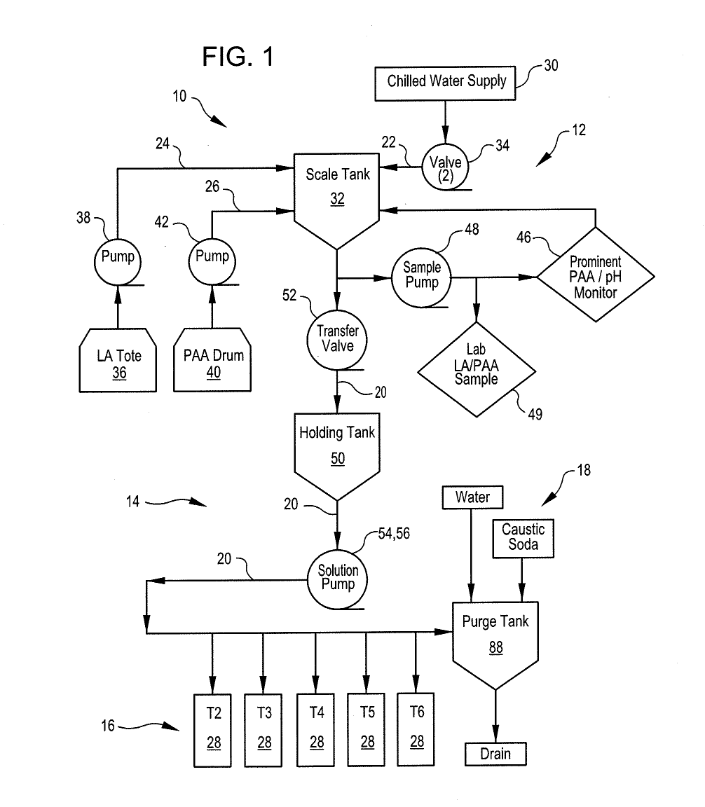

Referring now to the drawings, in which like reference numerals represent like parts throughout the several views, FIG. 1 diagrammatically illustrates a sanitation system 10, in accordance with many embodiments, that can be used to sanitize produce such as fruits and vegetables. The sanitation system 10 includes a treatment-solution concentrate preparation subsystem 12, a delivery subsystem 14, a treatment subsystem 16, and a purge subsystem 18. The treatment-solution concentrate preparation subsystem 12 prepares an aqueous treatment-solution concentrate 20 that includes a mixture of water 22, lactic acid (LA) 24, and peroxyacetic acid (PAA) 26 (also know as peracetic acid). The treatment-solution concentrate 20 is supplied to the treatment subsystem 16 by the delivery subsystem 14. The treatment subsystem 16 dilutes the treatment-solution concentrate 20 to form a treatment solution and uses the treatment solution to treat produce. The treatment subsystem includes one or more treatment lines 28 (e.g., five treatment lines (T2) through (T6) as shown) used to treat the produce. The purge system 18 is configured to receive and treat treatment-solution concentrate 20 purged from the treatment-solution concentrate preparation subsystem 12 and/or treatment solution purged from the treatment subsystem 16 prior to discharge of the resulting waste fluid to, for example, a waste water treatment facility such as a municipal waste water treatment facility. While the sanitation system 10 is described with reference to a treatment solution comprising water, LA, and PAA, the sanitation system 10 can be adapted for use with other suitable treatment solutions, for example, with other treatment solutions disclosed in the references incorporated by reference above.

Treatment-Solution Concentrate Preparation Subsystem

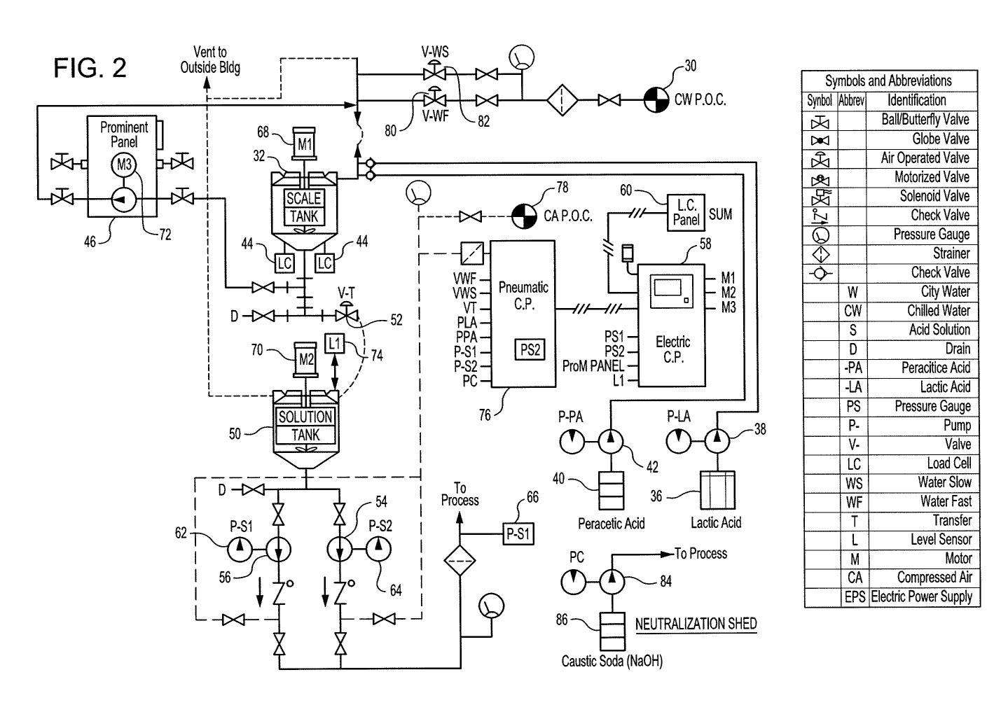

The treatment-solution concentrate preparation subsystem 12 includes a chilled water supply 30 in controlled fluid communication with a scale tank 32 via a chilled water valve 34, an LA container 36 (e.g., a 300 gallon intermediate bulk container (IBC)) in controlled fluid communication with the scale tank 32 via an LA pump 38, and a PAA container 40 (e.g., 55 gallon drums banded four to a plastic pallet) in controlled fluid communication with the scale tank 32 via a PAA pump 42. The chilled water valve 34, the LA pump 38, and the PAA pump 42 are selectively controlled to add controlled quantities of water, LA, and PAA to the scale tank 32. As illustrated in FIG. 2, the scale tank 32 is supported via loads cells 44 that sense weight changes of the scale tank 32 and are used to determine the weight of water added to the scale tank 32, the weight of LA added to the scale tank, and the weight of PAA added to the scale tank.

The scale tank 32 is in controlled fluid communication with a PAA measurement device 46 via a sample pump 48 as illustrated in FIG. 1 or via one or more valves as illustrated in FIG. 2. A suitable commercially available PAA measurement device 46 can be used, for example, a PAA measurement and control panel available from ProMinent Dosiertechnik GmbH, Im Schuhmachergewann 5-11, 69123 Heidelberg Germany. The PAA measurement device 46 can be used to check the concentration of the PAA in the resulting treatment-solution concentrate to determine if additional PAA or water needs to be added to the scale tank to adjust the concentration of the PAA to within a targeted range. A sample 49 of the resulting treatment-solution concentrate can be taken for laboratory analysis to determine the concentration of LA and/or PAA in the resulting treatment-solution concentrate.

The scale tank 32 is in controlled fluid communication with a holding tank 50 via a transfer valve 52. After completion of the mixing process, the resulting treatment-solution concentrate can be transferred to the holding tank 50. The holding tank 50 is in controlled fluid communication with the treatment subsystem 16 via one or more solution pumps in the delivery subsystem 14. In many embodiments, the solution pumps include two parallel solution pumps 54, 56 (e.g., diaphragm pumps, pressure-regulated variable-speed centrifugal pumps) that provide the ability to continue to pump the treatment-solution concentrate to the treatment subsystem 16 when one of the solution pumps is being repaired or replaced. In many embodiments, the capacity of the holding tank 50 exceeds the capacity of the scale tank 32 by an amount that provides some flexibility in the timing of the delivery of batches of treatment-solution concentrate to the holding tank 50. For example, the capacity of the holding tank 50 can be twice the capacity of the scale tank 32 (e.g., a 60 gallon scale tank and a 120 gallon holding tank, a 110 gallon scale tank and a 225 gallon holding tank, etc.).

A programmable logic controller (PLC) control panel 58 is used to control the operation of the treatment-solution concentrate preparation subsystem 12. The PLC control panel 58 is connected with a load cell panel 60 that is connected to the load cells 44, air actuators 62, 64 used to drive the solution pumps 54, 56, pressure transducer 66 that is connected the transfer line down stream of the holding tank 50, the PAA measurement device 46, a scale tank mixer 68, a holding tank mixer 70, a motor 72 in the PAA measurement device 46 that is used during the analysis of the sample, a holding tank level sensor 74, and a pneumatic control panel 76. The PLC control panel 58 receives corresponding data from the load cell panel 60, the pressure transducer 66, and the level sensor 74. For example, the pressure in the downstream line measured by the pressure transducer 66 can be displayed on screen and an alarm can be actuated in response to low pressure in the downstream line. The PLC control panel 58 controls the operation of the scale tank mixer 68, the holding tank mixer 70, the motor 72 in the PAA measurement device 46, the solution pumps 54, 56 via the air actuators 62, 64, and various pneumatically actuated components of the treatment-solution concentrate preparation subsystem 12 via a pneumatic control panel 76.

The pneumatic control panel 76 selectively controls the distribution of compressed air to the pneumatically actuated components of the treatment-solution concentrate preparation subsystem 12. The pneumatic control panel 76 is connected to a compressed air source 78. The pneumatic control panel 76 includes electric solenoid air valves (not shown) that are controlled by the PLC control panel 58 and thereby control the distribution of compressed air to the various pneumatically actuated components. Pneumatically actuated components of the treatment-solution concentrate preparation subsystem 12 that are controlled via the pneumatic control panel 76 include a water fast-fill valve 80, a water slow-fill valve 82, the transfer valve 52, the LA pump 38, the PAA pump 42, the solution pumps 54, 56, as well as a caustic soda pump 84 in the purge subsystem 18. The water fast-fill valve 80 and the water slow-fill valve 82 control the flow of water from the chilled-water source 30 to the scale tank 32. Opening the water fast-fill valve 80 causes chilled water to flow into the scale tank 32 at higher rate as compared to when just the water slow-fill valve 82 is open. The LA pump 38, the PAA pump 42, the solution pumps 54, 56, and the caustic soda pump 84 can be pneumatically-driven pumps. The LA pump transfers LA from the LA container to the scale tank. The PAA pump transfers PAA from the PAA container to the scale tank. The solution pumps transfer treatment-solution concentrate from the holding tank to the treatment subsystem 16, and the caustic soda pump 84 transfers caustic soda from a caustic soda container 86 to a purge tank 88 and to individual treatment lines 28.

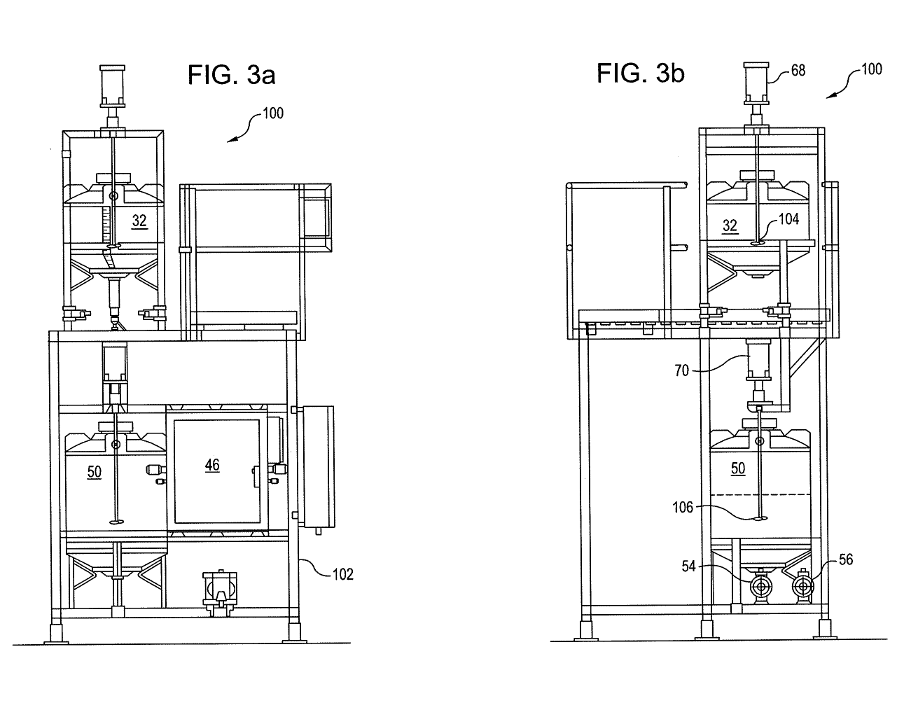

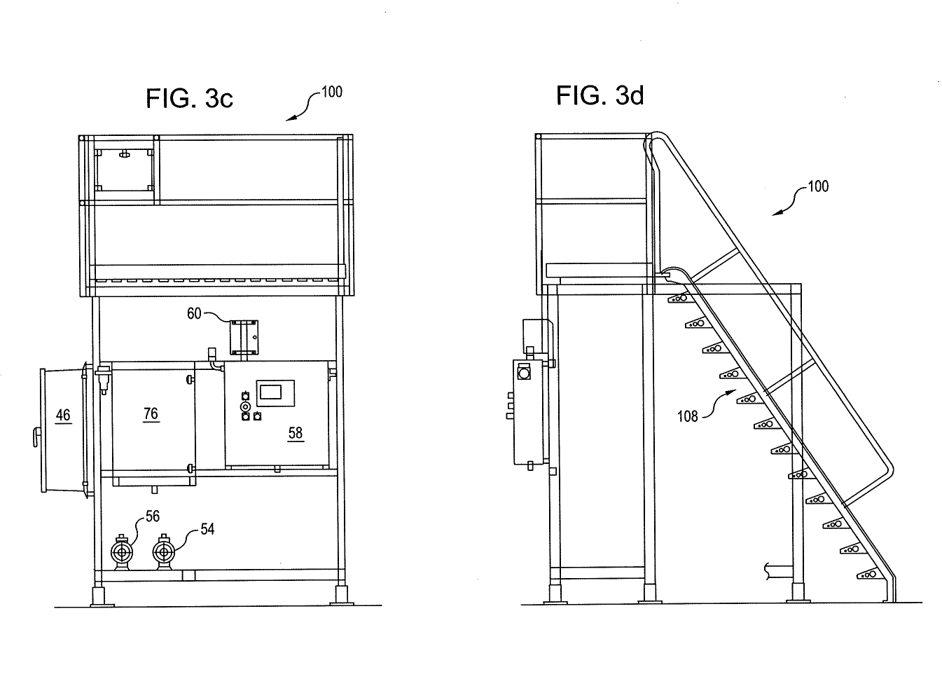

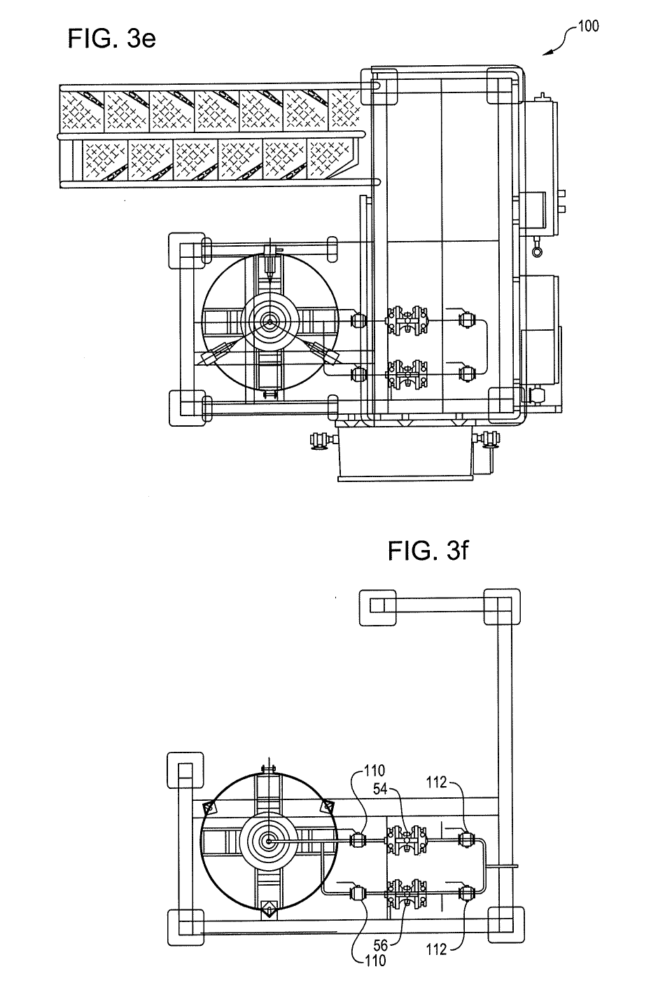

FIGS. 3a through 3f illustrate a batch mixing-tower platform assembly 100 in accordance with the treatment-solution concentrate preparation subsystem 12. FIG. 3a is a front view of the mixing tower 100. The mixing tower 100 includes a frame 102 that supports the scale tank 32 above the holding tank 50. Placing the scale tank 32 above the holding tank 50 provides for gravity induced transfer of newly mixed treatment-solution concentrate from the scale tank to the holding tank. The PAA measurement device 46 is mounted to the frame 102 at a suitable height for ease of access. FIG. 3b is a left-side view of the mixing tower 100 and illustrates the mounting of the scale tank mixer 68 used to drive a mixing propeller 104 in the scale tank 32 and the mounting of the holding tank mixer 70 used to drive a mixing propeller 106 in the holding tank 50. The solution pumps 54, 56 are mounted adjacent to and generally beneath the holding tank 50. FIG. 3c is a rear-side sectional view of the mixing tower 100 and illustrates the mounting of some of the components of the concentration preparation subsystem 12 to the mixing tower 100. For example, the PAA measurement device 46 is shown mounted to the front side of the mixing tower 100. The pneumatic control panel 76, the load cell panel 60, and the PLC control panel 58 are mounted to the right side of the mixing tower. And the solution pumps 54, 56 are also shown from the right side of the mixing tower. FIG. 3d is a rear-side sectional-view illustration of the mixing tower 100. A set of stairs 108 provides access to the scale tank and associated components. FIG. 3e is a plan view of the mixing tower 100. FIG. 3f illustrates section A-A as located in FIG. 3a. Section A-A illustrates the parallel installation of the solution pumps 54, 56 along with inlet-side isolation valves 110 and outlet-side isolation valves 112 that can be used to isolate one of the solution pumps (e.g., for maintenance, repair, replacement) while the other solution pump is used to transfer treatment-solution concentrate from the holding tank to the treatment subsystem.

The LA and the PAA used by the treatment-solution concentrate preparation subsystem can be supplied at a frequency selected to keep stored inventory at a minimum. The PAA can be received, for example, at a 15% concentration in 55 gallon drums banded four to a pallet. The LA can be received, for example, at an 88% concentration in 300 gallon intermediate bulk containers (IBCs). The chemical suppliers can be requested to provide a closed-transfer dispenser with each container. Empty LA and PAA containers can be recycled to the supplier. Various usage rates for the LA and PAA are possible. For example, for one exemplary usage rate, the anticipated consumption rate is 4 to 5 days for one drum of PAA and the same for one IBC of LA. Suitable storage of the chemicals (e.g., LA, PAA, caustic soda) can be employed. For example, the chemicals can be stored at a temperature of 34 to 39 degrees Fahrenheit on spill containment units located in a raw materials warehouse. Various amounts of the chemicals can be stored. For example, in an exemplary raw materials warehouse, provisions for storing two pallets (8 drums) of PAA and three IBCs of LA are provided.

Suitable safety precautions can (and should) be used when handling the chemicals. For example, operators can connect a transfer hose to closed-transfer dispensers installed on each PAA drum and each LA IBC. The LA container can be separated from the PAA container(s) by a minimum of 8 feet and floor ventilation can exhaust any fumes emitted from the PAA container(s) into a water scrubber. Only trained personnel wearing full protective gear can be allowed to handle the chemicals. Emergency spills can be handled by local fire department personnel.

In many embodiments, the mixing of the water, the LA, and the PAA in the scale tank is computer controlled and weight based. The scale tank can be used to mix the two acids with water to create a treatment-solution concentrate that is, for example, 100 times more concentrated than the treatment solution used in the treatment subsystem. In many embodiments, a 100× treatment-solution concentrate equates to 25% LA and 0.75% PAA. In some embodiments, the scale tank has a 60 gallon capacity and is mounted on loads cells and positioned over a 120 gallon holding tank. In other embodiments, the scale tank as a 110 gallon capacity and is mounted on load cells and positioned over a 225 gallon holding tank. Each LA and PAA container can be sampled prior to use to verify concentration of the delivered acids. The measured concentrations can be entered into the PLC control panel 58. The operator can enter the desired batch volume into the PLC control panel via a touch screen monitor and can start the mixing cycle by touching a start icon. Batch volume selection can be limited to between a maximum of 50 gallons and a minimum of 30 gallons. Using a 50 gallon maximum may leave a suitable reserve capacity in the scale tank. Using a 30 gallon minimum may help to ensure acceptable accuracy for the minimum batch volume. The PLC control panel can calculate weight set points for the three ingredients and open the water fast-fill valve 80 (and in some embodiments also open the water slow-fill valve 82) to start adding water to the tank. When the water weight in the scale tank reaches, for example, 90% of the set point for the water, the water fast-fill valve can be closed and the water slow-fill valve can be opened if not already open. When the water weight in the scale tank reaches the set point, the water slow-fill valve can be closed.

In many embodiments, the LA pump 38 and the PAA pump 42 are air-operated double diaphragm pumps having two speeds. Transfer of the LA to the scale tank can be accomplished first with the LA pump initially run at a high flow rate. When the LA weight in the scale tank reaches, for example, 90% of the set point for the LA, the LA pump can be switched to run at a low flow rate until the LA weight in the scale tank reaches the set point. Next, the PAA can be transferred to the scale tank with the PAA pump initially run at a high flow rate. When the PAA weight in the scale tank reaches, for example, 90% of the set point for the PAA, the PAA pump can be switched to run at a low flow rate until the PAA weight in the scale tank reaches the set point. The scale tank mixer 68 can be used to drive the mixing propeller 104 in the scale tank to mix the water and the two acids for a preset time before the sample pump 48 circulates a sample of the mixture from the scale tank through the PAA measurement device to measure the pH of the sample. A sample can also be extracted for lab titration measurement of LA content. When the LA concentration has been confirmed to be correct, the mixing cycle can be manually restarted, the propeller mixer can then stop and the chemical measuring sequence using the PAA measurement device can be repeated. In many embodiments, the PAA measurement device includes a 10,000 ppm ProMinent sensor.

Prior to transfer of a freshly mixed batch of treatment-solution concentrate from the scale tank to the holding tank, the PLC control panel can verify (via the level sensor 74 in the holding tank) that adequate capacity is available in the holding tank to receive the full quantity of fluid in the scale tank. If adequate volume exists, a monitor can display status and an operator can touch a button icon on a touch screen to open the transfer valve and complete a gravity induced transfer between the scale tank and the holding tank.

Data for each batch of treatment-solution concentrate can be stored in memory. For example, batch size, concentration set points, input acid concentrations, measured component weights, pH and PAA concentration measurements, date, batch number, and/or transfer time(s) can be stored in memory.

The PLC control panel can implement an algorithm that accounts for fluid downstream of the water slow-fill valve, the LA transfer pump, and/or the PAA transfer pump that has not reached the scale tank when the water slow-fill valve is closed and/or when the LA and/or PAA transfer pump are stopped during the process of transferring the water, the LA, and/or the PAA to the scale tank. For example, the fluid downstream of the corresponding valve or pump that has not yet reached the scale tank can be accounted for when determining when to close the water slow-fill valve and/or when to stop the LA and PAA transfer pumps. Such an adjustment can be initially manually input, but can be automated based on corresponding weight data from earlier batches. The load cell controller 60 can include a vibration cancellation feature that effectively filters out noise of repetitive external disturbances.

Although various daily usages of treatment-solution concentrate are possible; one exemplary daily usage rate is 250 gallons (e.g., five 50 gallon batches). Total automation of the mixing and transfer operations can be implemented using, for example, the PLC control panel.

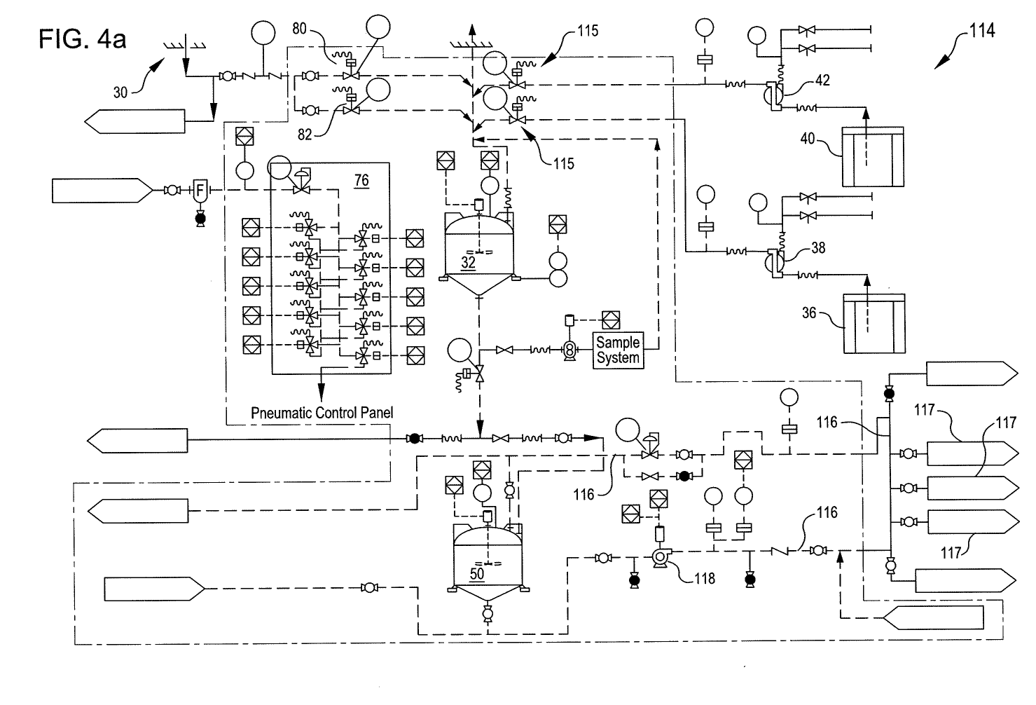

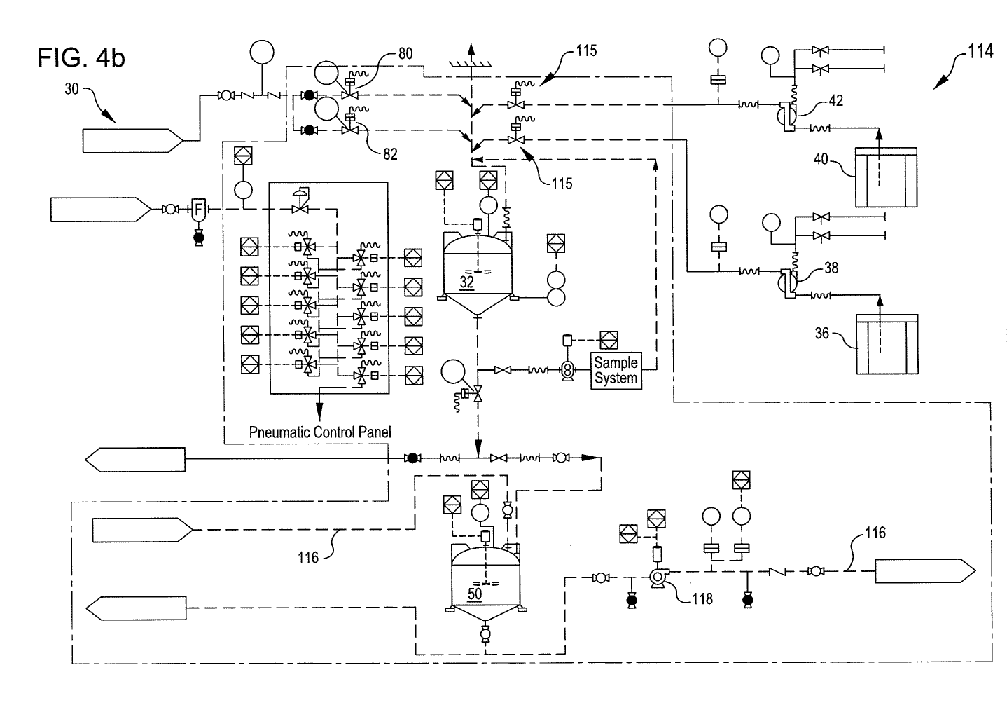

FIGS. 4a and 4b illustrates a mixing subsystem 114 that employs two scale tanks 32 and associated two holding tanks 50. The two scale tanks and associated holding tanks provide parallel redundant capacity to produce the treatment-solution concentrate. The mixing subsystem 114 can include components similar to the mixing subsystem 10 of FIG. 1. The similar components are labeled with the same reference numerals. The foregoing discussion of such similar components is applicable here and therefore is not repeated here.

The mixing subsystem 114 does, however, have some notable differences with respect to the mixing subsystem 10 of FIGS. 1 and 2. For example, the mixing subsystem 114 includes metering valves 115 that are located adjacent to the mixing tank so as to limit the amount of LA and/or PAA disposed between the metering valves and the mixing tank when the metering valves are closed, thereby limiting the amount of LA and/or PAA that flows into the mixing tank following the closing of the metering valves. The mixing subsystem 114 also uses a recirculation loop 116 through which solution-treatment concentrate received from the holding tank is routed past distribution outlets 117 and then circulated back to the holding tank. And the mixing subsystem 114 uses pressure-regulated variable-speed centrifugal distribution pumps 118 that are regulated to generate a suitable pressure of the solution-treatment concentrate at the distribution outlets 117. Because of the parallel configuration of the two mixing tanks and the associated two holding tanks, the mixing subsystem 114 achieves the same ability for continuous operation during maintenance activities as in the mixing subsystem 10 of FIGS. 1 and 2.

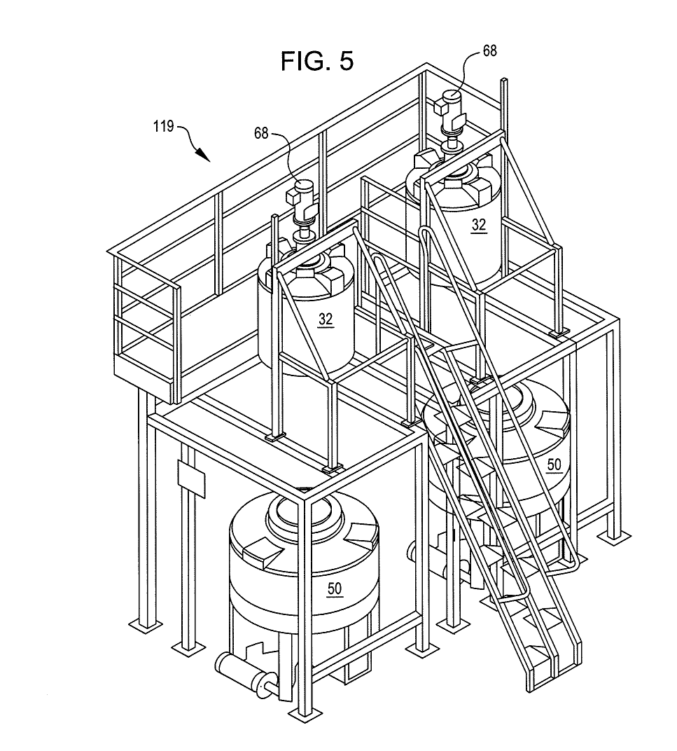

FIG. 5 is a perspective view illustration of a batch mixing-tower platform assembly 119 in accordance with the treatment-solution concentrate preparation subsystem 114. The batch mixing-tower platform assembly 119 can include components similar to the mixing subsystem 10 of FIG. 1. The similar components are labeled with the same reference numerals. The foregoing discussion of such similar components is applicable here and therefore is not repeated here.

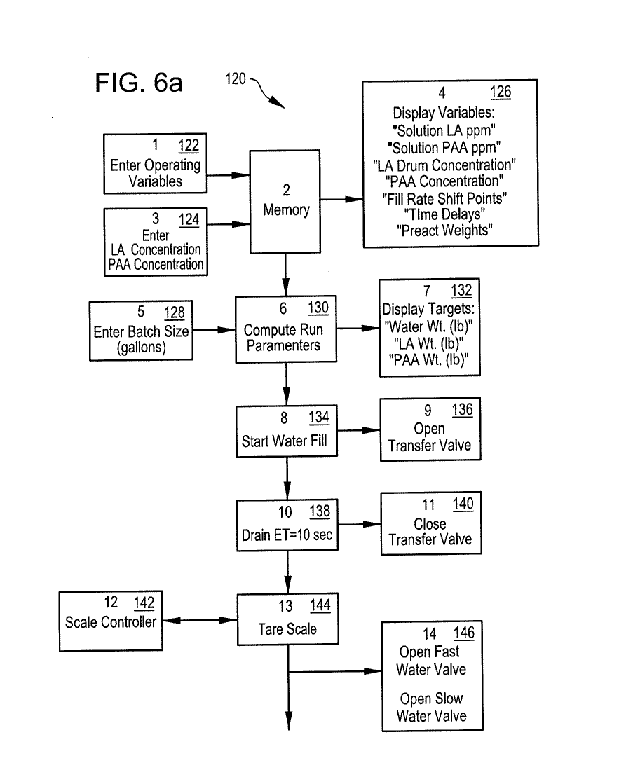

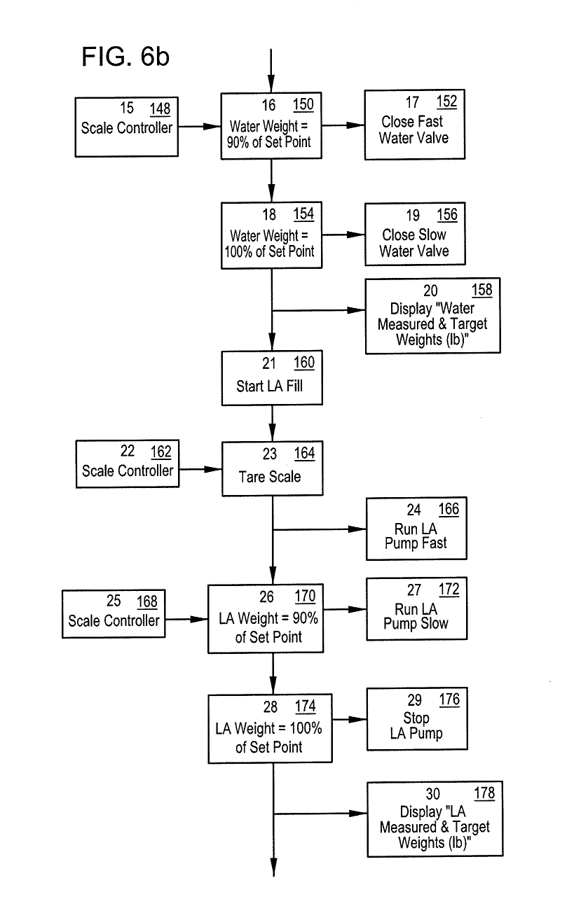

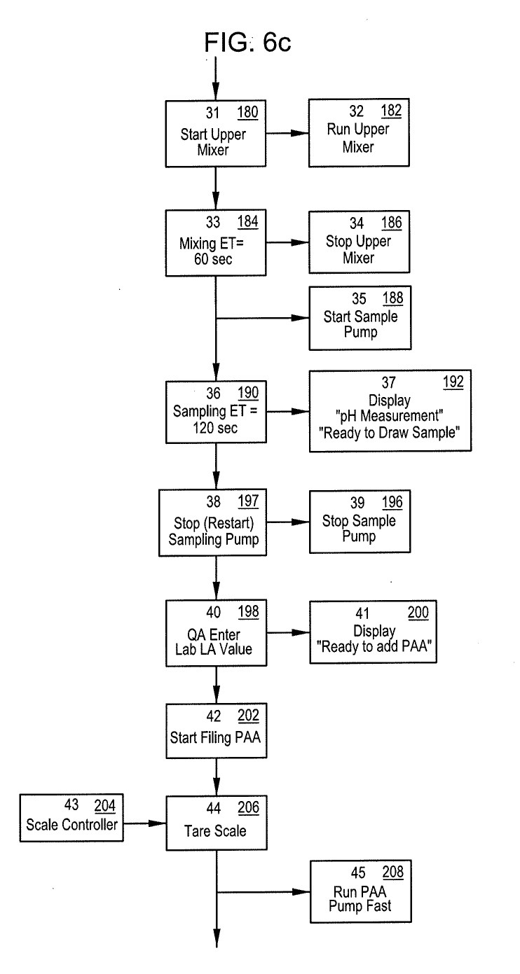

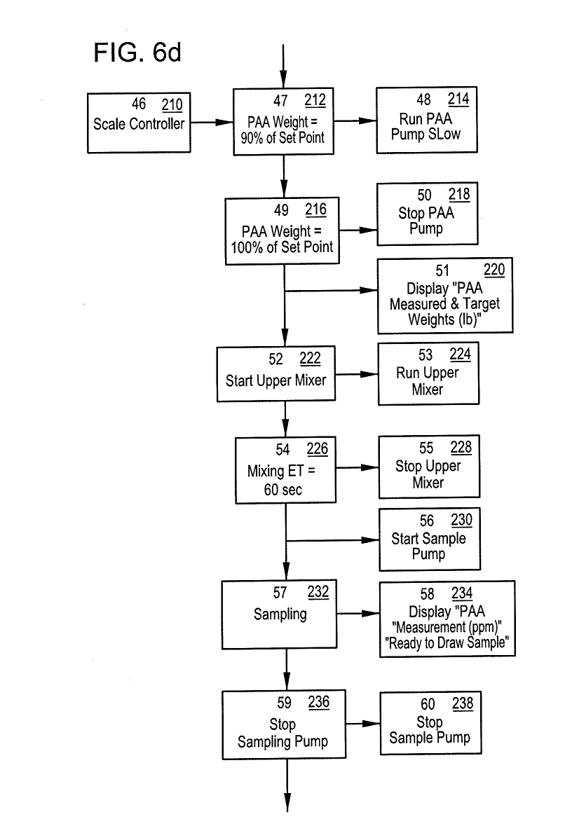

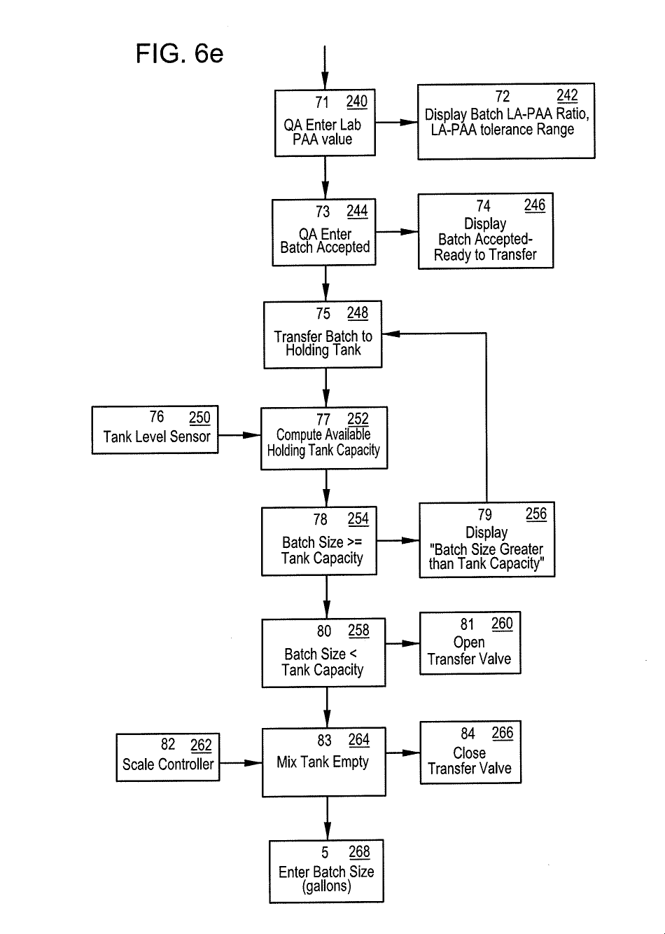

FIGS. 6a through 6e illustrate a mixing algorithm 120 for the treatment-solution concentrate preparation subsystem 12, in accordance with many embodiments. In steps 122 and 124, operating variables and operating values (e.g., LA concentration (ppm) for the treatment-solution concentrate, PAA concentration (ppm) for the treatment-solution concentrate, LA concentration in the LA container, PAA concentration in the PAA container, fill rate shifts points, time delays, and/or “preact weights” used to account for fluid in the air during transfer of component fluids into the scale tank) are entered into memory in the PLC control panel. In step 126, the operating variable and values can be displayed to, for example, provide a means by which they can be verified by an operator.

In step 128, the batch size is entered and used in step 130 to calculate run parameters for the batch. In step 132, the target weights for water, LA, and PAA can be displayed to allow, for example, operator verification.

Step 134 signifies the start of the addition of water to the scale tank. Steps 136 through 140 ensure that the scale tank is empty at the start of the mixing process. In step 136, the transfer valve between the scale tank and the holding tank is opened. The transfer valve is kept open for, for example, about 10 seconds as signified in step 138. The transfer valve is then closed in step 140.

In steps 142 and 144, the empty weight of the scale is determined for use in determining the amount of water subsequently added. In step 146, both the water fast-fill valve and the water slow-fill valve are opened to add water to the scale tank at a high rate. In step 148, the scale controller is used to monitor the weight of water in the scale tank and when the weight of the water reaches, for example, 90% of the set point in step 150, the water fast-fill valve is closed in step 152. When the water weight in the scale tank reaches the set point in step 154, the water slow-fill valve is closed in step 156. In step 158, the water measured and target weights are displayed.

Step 160 signifies the start of addition of LA to the scale tank. In steps 162 and 164, the scale controller is used to determine a reference starting weight of the scale tank and water for use in determining the amount of LA subsequently added. In step 166, the LA pump is run at a high flow rate to add LA to the scale tank. In step 168, the scale controller is used to monitor the weight of LA added to the scale tank. When the weight of LA in the scale tank reaches, for example, 90% of the set point in step 170, the LA pump is switched to run at a low flow rate in step 172. When the weight of LA in the scale tank reaches the set point in step 174, the LA pump is stopped in step 176. In step 178, the LA measured and target weights are displayed.

In steps 180 through 200, the water and the LA are mixed and a sample of the resulting mixture is extracted and analyzed to determine its LA concentration. In steps 180 through 186, the upper tank mixer is used to mix the water and the LA for a period of time, for example, for about 60 seconds. In steps 188 through 196, the sample pump is used to extract a sample of the water and LA mixture for analysis. The determined concentration of LA in the sample is then input in step 198, and then a “Ready to add PAA” message is displayed in step 200.

Step 202 signifies the start of addition of PAA to the scale tank. In steps 204 and 206, the scale controller is used to determine a reference starting weight of the scale tank, water, and LA for use in determining the amount of PAA subsequently added. In step 208, the PAA pump is run at a high flow rate to add PAA to the scale tank. In step 210, the scale controller is used to monitor the weight of PAA added to the scale tank. When the weight of PAA in the scale tank reaches, for example, 90% of the set point in step 212, the PAA pump is switched to run at a low flow rate in step 214. When the weight of PAA in the scale tank reaches the set point in step 216, the PAA pump is stopped in step 218. In step 220, the PAA measured and target weights are displayed.

In steps 222 through 238, the water, LA, and PAA are mixed and a sample is extracted for laboratory analysis and/or analysis by the PAA measurement device. In steps 222 through 228, the scale tank mixer is run for a period of time, for example, about 60 seconds. In steps 230 through 238, the sample pump is used to extract a sample of the mixed water, LA, and PAA for analysis to determine the PAA concentration in the sample. The PAA concentration can be determined via laboratory analysis and/or analysis by the PAA measurement device. The resulting PAA concentration can be entered if necessary (e.g., when obtained via laboratory analysis) in step 240. In step 242, the resulting PAA concentration in the batch is displayed along with the acceptable range for the PAA concentration. If within acceptable ranges, the batch can be accepted in step 244 and indicated to be ready for transfer to the holding tank in step 246.

Step 248 signifies the start of the transfer of the batch of treatment-solution concentrate from the scale tank to the holding tank. In step 250, a signal level from the scale tank level sensor is determined and used in step 252 to compute the available holding tank capacity. If the batch size is determined to exceed the available holding tank capacity in step 254, a warning message such as “Batch Size Greater than Tank Capacity” is displayed in step 256 and transfer is inhibited until the available holding tank capacity exceeds the batch size. If the batch size is determined to be less than the available holding tank capacity in step 258, the transfer valve is opened in step 260. The scale controller is used to monitor the scale tank in step 262 to determine when the scale tank is empty as signified in step 264, whereupon the transfer valve is closed in step 266 and the mixing of the next batch can start with the entry of the next batch size in step 268.

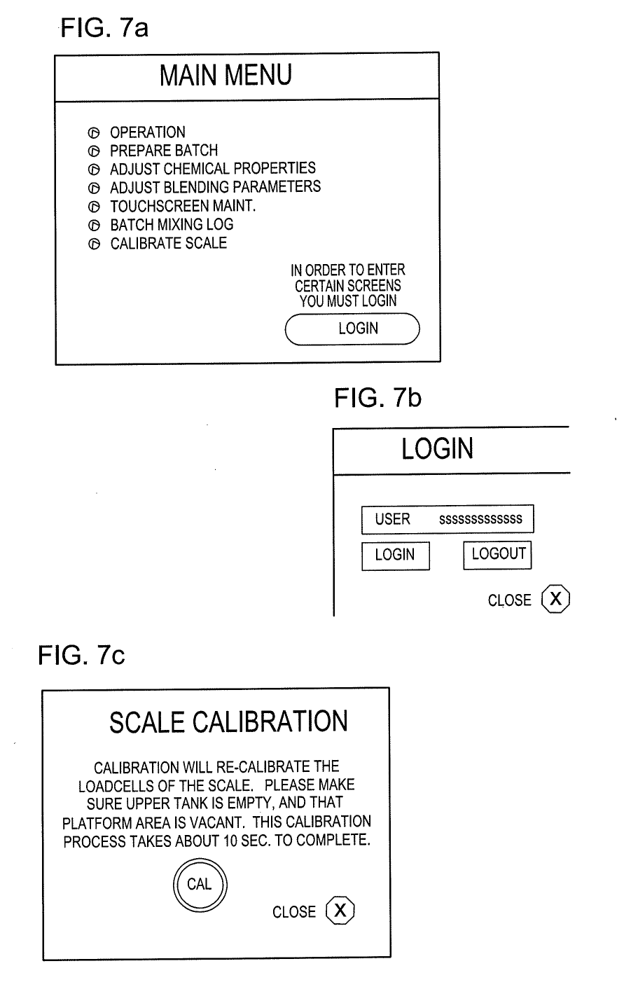

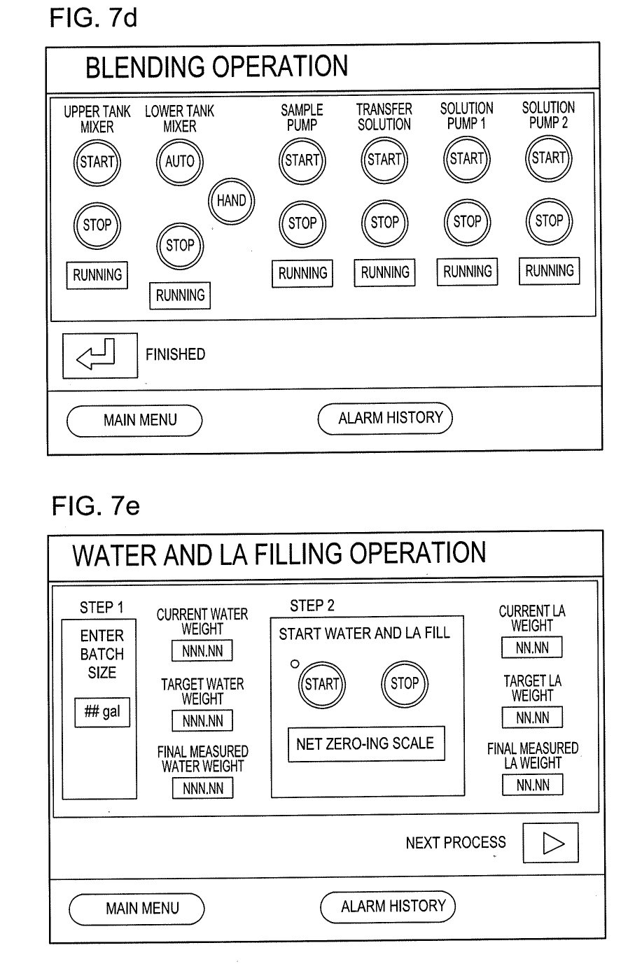

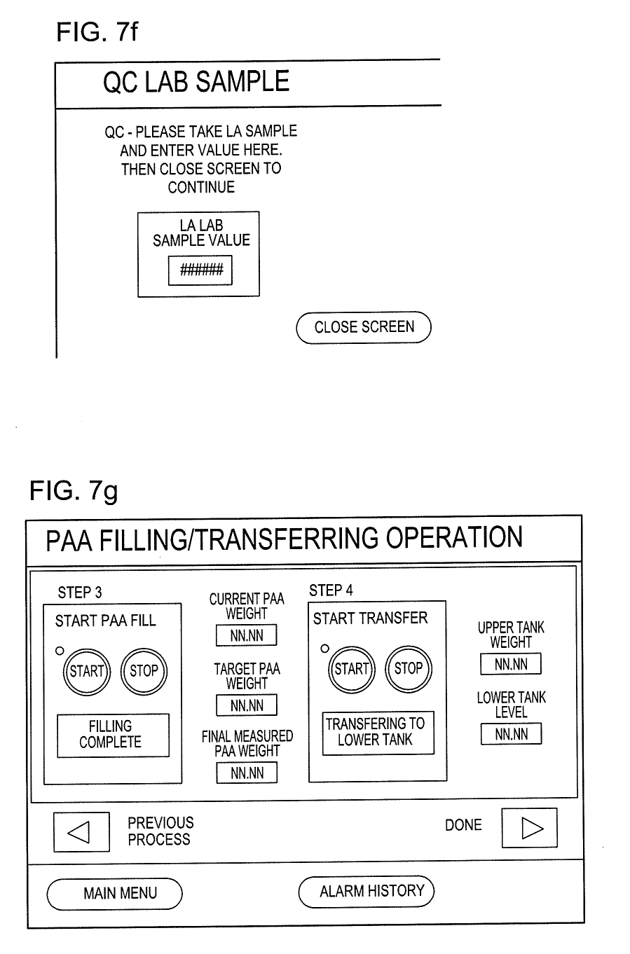

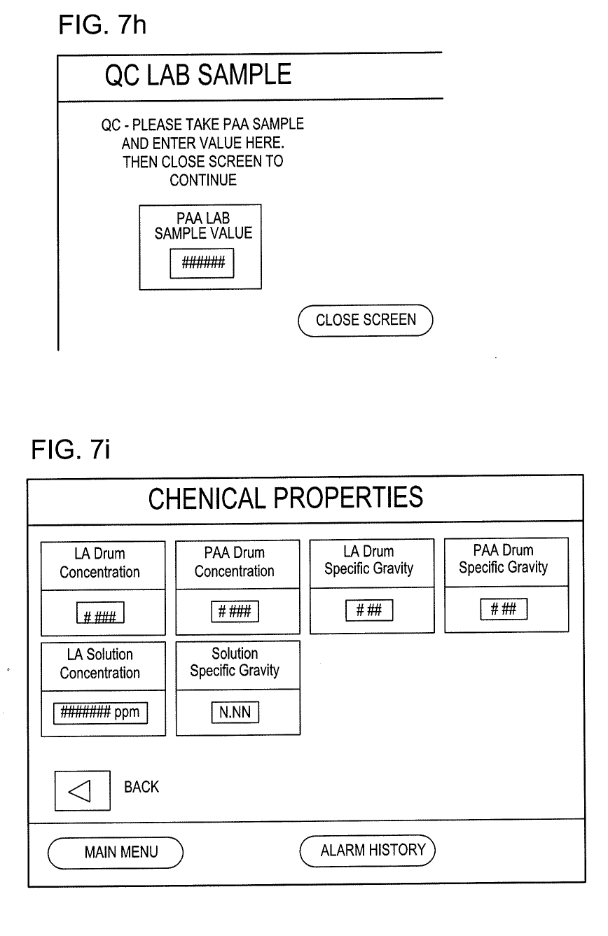

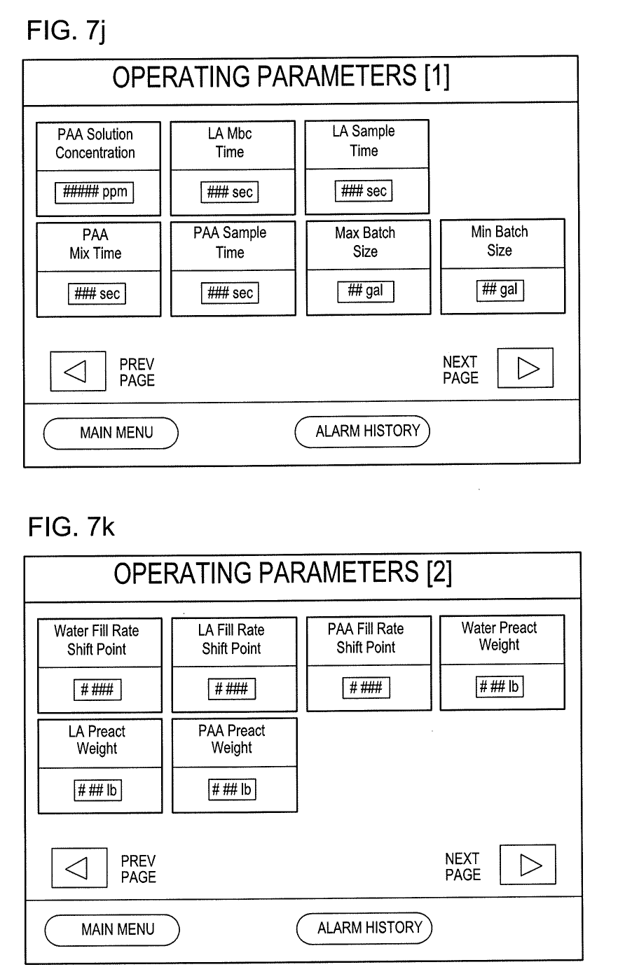

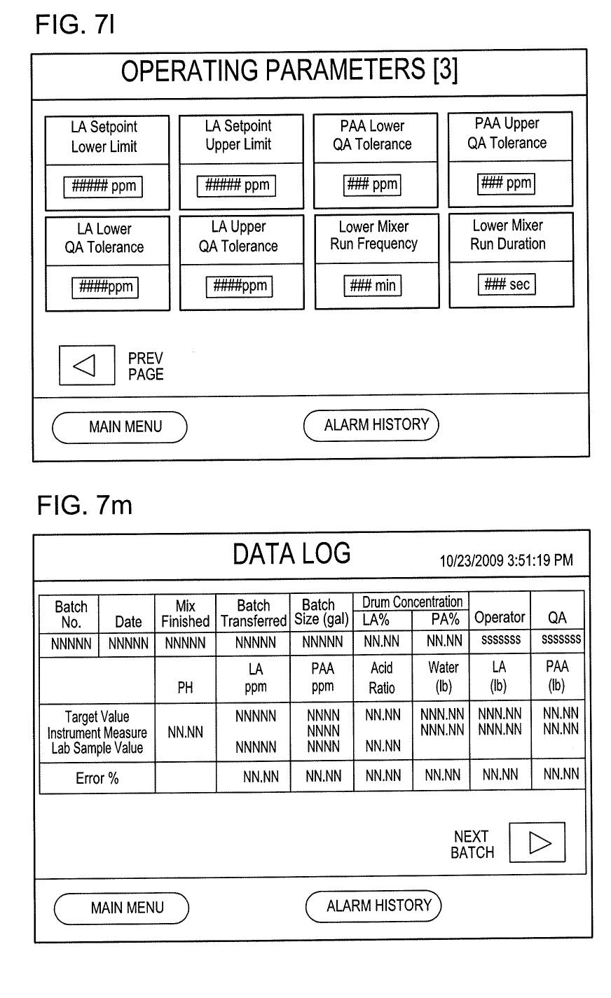

FIGS. 7a through 7m illustrate user interface screens for the treatment-solution concentrate preparation subsystem, in accordance with many embodiments. FIG. 7a shows a top level menu screen used to select from the illustrated system functions. FIG. 7b show a user login screen used to gain access to certain of the functions illustrated in FIG. 7a. FIG. 7c shows a scale calibration screen used to recalibrate the scale tank load cells and accessible by selecting the “calibrate scale” function in the top level menu screen. FIG. 7d shows a blending operation screen that can be used to control the upper tank mixer (scale tank mixer), the lower tank mixer (holding tank mixer), the sample pump, the transfer valve, and the solution transfer pumps. FIG. 7e shows a screen used to start and stop the water and LA filling operations and to display the related parameters shown for the water and LA filling operations. FIG. 7f shows a QC lab sample screen used to indicate when a LA sample should be taken and provides for the input of the measured LA concentration into the system. FIG. 7g shows a screen used to start and stop the PAA filling operation and to start and stop the transfer of the treatment-solution concentrate batch to the holding tank and to display related parameters for the PAA filling and transfer operations. FIG. 7h shows a QC lab sample screen used to indicate when a PAA sample should be taken and provides for the input of the measured PAA concentration into the system. FIG. 7i shows a chemical properties screen that can be used to adjust chemical property parameters for the LA, PAA, and the resulting treatment-solution concentrate. The chemical properties screen is accessed by selecting “adjust chemical properties” in the top level men. FIGS. 7j through 7l show operating parameters screens that can be used to adjust operating parameters of the treatment-solution concentrate preparation subsystem. The operating parameters screens are accessed by selecting the “adjust blending parameters” in the top level menu. FIG. 7m shows a data log for a selected batch of treatment-solution concentrate. The “next batch” icon can be scroll through the data logs for other batches.

In many embodiments, the treatment-solution concentrate preparation subsystem 12 is configured so that the treatment-solution concentrate can be conveniently purged from the treatment-solution concentrate preparation subsystem. Additional discussion of system purging is discussed below.

Delivery Subsystem

The delivery subsystem 14 illustrated in FIG. 1 includes the solution pumps 54, 56, a delivery line, and a common manifold that distributes the treatment-solution concentrate to the treatment lines 28 of the treatment subsystem 16. Each solution pump 54, 56 can be a suitable pump (e.g., a pneumatically operated diaphragm pump, a pressure-regulated variable-speed centrifugal pump). One or more solution pumps can be used to maintain a constant pressure in the common manifold and pump only the volume of solution required to meet demand. In many embodiments, the holding tank mixer 70 keeps the chemical components in solution.

Two solution pumps installed in parallel can be used to increase reliability. The common manifold can have a pressure sensor (e.g., see pressure sensor 66 in FIG. 2) that is electrically coupled with the PLC control panel 58. The PLC control panel can monitor the pressure in the common manifold to regulate the operation of the solution pumps and also to annunciate a solution pump fault message when the pressure in the common manifold falls outside of a normal operational range. For example, when the pressure in the common manifold falls below the normal operational range and a fault message can be annunciated, a second solution pump can be started with a push of a button on a touch screen coupled with the PLC control panel.

Existing materials can be used in the delivery system. For example, 316 stainless steel tubing can be used in the delivery system and both the scale tank and the holding tank can be constructed of high-density polyethylene.

In many embodiments, the delivery system is configured so that the treatment-solution concentrate can be conveniently purged from the delivery system. Additional discussion of system purging is provided below.

Treatment Subsystem

The treatment subsystem 16 can include one or more treatments lines 28. Each treatment line can be configured to treat one or more types of produce, thereby allowing customization of the overall treatment system suitable for the range of produce to be treated. A treatment line can include a washing station where the treatment solution is contacted with exterior surfaces of the produce. Various suitable approaches can be used to contact exterior surfaces of the produce with the treatment solution, for example, spraying and/or immersion.

The concentration of PAA in the treatment solution and the pH of the treatment solution can be monitored and controlled, for example, by using a pair of ProMinent Dulcometers available from ProMinent Dosiertechnik GmbH, Im Schuhmachergewann 5-11, 69123 Heidelberg Germany. Measurement of the concentration of PAA can be based on the measurement of hydrogen peroxide, which is a component of PAA. Suitable control limits for the concentration of PAA can be used, for example, 65 to 75 parts per million (ppm). In many embodiments, the concentration of LA in the treatment solution is not measured and is assumed to remain stable in a fixed ratio with the PAA (e.g., 28.5 to 1) as established in the scale tank, for example, between 1800 ppm and 2200 ppm. Because of the higher concentration of the LA in the treatment solution, the LA has a greater influence on the pH of the treatment solution than the PAA. The pH of the treatment solution can be used as an indicator of the concentration of LA in the treatment solution. And it may be possible to establish suitable control limits based on the pH of the treatment solution.

The measured concentration of PAA can be used to regulate a digital-feed valve to dispense a suitable quantity of the treatment-solution concentrate into the treatment solution in use (e.g., the treatment solution within a treatment line) so as to regulate the concentration of PAA in the treatment solution. For example, the ProMinent Dulcometer uses a proportional-integral-derivative (PID) feedback algorithm to create a square-wave signal controlling the digital-feed valve. The period between opening the digital-feed valve and closing the digital-feed valve can be varied to satisfy a dose conditions for initial filling and for normal operation. During normal operation, typically only enough treatment-solution concentrate is added to compensate for make-up water added to replace treatment solution removed by the product and/or spilled from the treatment line(s).

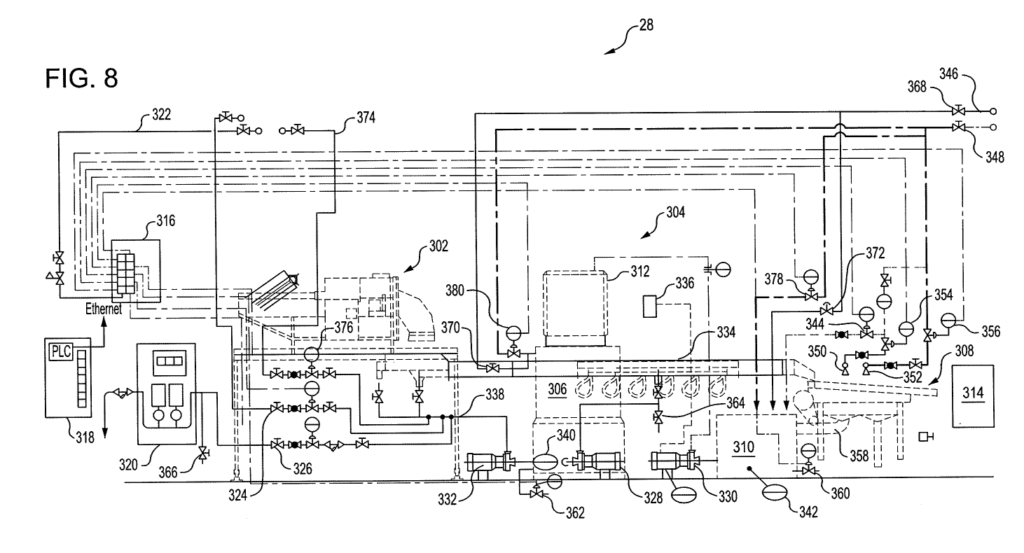

FIG. 8 shows a piping and installation diagram for an example treatment line 28 of the treatment subsystem 16 of FIG. 1, in accordance with many embodiments. The treatment line 28 shown is configured for the treatment of leafy vegetables (e.g., romaine lettuce). Other treatment line configurations, however, can be used to treat other types of produce. For example, treatment lines can be configured to treat any type of produce such as defined in U.S. Patent Publication No. 2009/0324789, which is incorporated by reference above. The treatment line 28 illustrated includes a chopper/separator station 302 where the leafy vegetable is introduced into the treatment line, a washing station 304 where the leafy vegetable is immersed in the treatment solution, a chiller 306 to maintain the treatment solution within a suitable temperature range (e.g., 33 to 39 degrees Fahrenheit), a shaker table 308 where the leafy vegetable is shaken to remove treatment solution that is clinging to the leafy vegetable, a shaker return tank 310 to accumulate treatment solution to be recycled back through the treatment line, and a hydro sieve 312 to remove particulate matter from the treatment solution before the treatment solution enters the chiller 306.

Components used to control the treatment line 28 include a PLC control panel 314, a pneumatic control panel 316, a process panel 318, a chemical panel 320, various pneumatic valves, flow sensors, pressure transducers, a temperature sensor, and electric pumps. The PLC control panel 314 can be used to provide top-level control of the treatment line 28 and can, for example, include a programmable controller executing a control algorithm, a display, and suitable input/output devices. In many embodiments, the PLC control panel 314 includes a touch screen display for displaying control screens and/or system messages to an operator and for receiving operator input. The PLC control panel 314 can receive input from the chemical panel and/or the various sensors and output control signals to the pneumatic control panel 316 to control the various pneumatic valves via associated solenoids in the pneumatic control panel 316. The pneumatic control panel 316 is coupled with a compressed air source 322 that provides the compressed air distributed by the pneumatic control panel 316.

The chemical panel 320 includes a PA monitor and a pH monitor to measure the concentration of the PAA in the treatment solution and the pH of the treatment solution. The measured values are used to regulate an acid supply valve 324 to add treatment-solution concentrate into the treatment solution when the measured level of PAA concentration and/or pH level so indicate. A sampling control valve 326 is used to control the flow of treatment solution through the chemical panel 320. The treatment solution exiting the chemical panel is then recycled back into the circulating treatment solution.

During operation of the treatment line, the treatment solution is circulated within the treatment line via a high-residency (HR) zone pump 328, a chiller return pump 330, and a flume inlet pump 332. The HR zone pump circulates chilled treatment solution from the chiller to a HR zone 334 of the washing station 304. Treatment solution from the HR zone is routed through the hydro sieve 312 before being returned to the chiller 306. The chiller return pump circulates treatment solution from the shaker return tank to the hydro sieve. And from the hydro sieve, the treatment solution circulates to the chiller. The chiller return pump is a variable-speed pump controlled by a variable frequency drive 336. The flow rate of the chiller pump is controlled to maintain the fluid level within the chiller within operational limits. The flume inlet pump circulates chilled treatment solution from the chiller to an inlet flume 338. Chilled treatment solution from the inlet flume is introduced into the washing station down stream of the chopper/separator station. The treatment solution introduced into the washing station by the flume inlet pump is then circulated back to the chiller.

In many embodiments, the treatment solution is introduced at the flume inlet. Produce, either whole or cut, is introduced into the flume immediately after the point of treatment solution introduction. The produce is conveyed by the treatment solution through the flume. Agitation jets employing treatment solution and/or air help to submerge the produce and create a scouring action on the surface of the produce enhancing the cleaning action. The flume discharges onto a vibratory conveyor or perforated belt conveyor where the treatment solution and the produce are separated. The produce continues on to a drying process and the treatment water is routed to the shaker return tank from which it is routed for filtering, chilling, and recirculation back to the flume. In many embodiments, a treatment line is elevated and the water passed via gravity through a self-cleaning sieve on its way to a return tank located below the washer. The process is repeated for a double wash treatment system.

The amount of treatment solution circulated within the treatment line is regulated via level sensing pressure transducers. A first level sensing pressure transducer 340 senses the pressure within the chiller and a second level sensing pressure transducer 342 senses pressure within the shaker return tank. When the level of treatment solution within the chiller falls below a designated level, the chiller pump is operated to transfer treatment solution from the shaker return tank to the chiller. When the level of treatment solution within the shaker return tank falls below a designated level, chilled makeup water can be added to the shaker return tank via a wash tank makeup valve 344.

The treatment line 28 can be coupled with two sources of water (e.g., a source of un-chilled water 346, a source of chilled water 348). The chilled water can be used to supply a first spray bar 350 and a second spray bar 352 through a first spray bar control valve 354 and a second spray bar control valve 356, respectively, so as to spray/rinse treated produce in the shaker table. Some of the chilled water sprayed on the produce may be circulated to the shaker return tank via a shaker table return pipe 358, thereby serving to supply makeup water to the system. The chilled water can also be directly directed into the shaker return tank via the wash tank makeup valve 344.

The treatment line is also configured so that the treatment solution can be drained, the treatment line rinsed, and the treatment line refilled with fresh treatment solution by adding water and treatment-solution concentrate into the system in appropriate quantities. To drain treatment solution from the treatment line, a shaker tank drain valve 360 can be opened to drain the shaker tank, a chiller drain valve 362 can be opened to drain the chiller, a washing station drain valve 364 can be opened to drain the washing station, and a chemical panel drain 366 can be opened to drain the chemical panel. To rinse the treatment line, water, for example, un-chilled water can be added into the treatment line via valves 368, 370, 372. The water can then be circulated throughout the treatment line using the pumps 328, 330, 332 and then drained. One or more batches of water can be added to, circulated through, and drained from the treatment line to provide a desired level of rinsing. During the rinsing process, the chemical panel can be used to monitor the pH level of the fluid in the treatment line to provide feedback that can be used to determine, for example, whether to perform additional rinsing and/or whether the fluid drained from the treatment line should be treated to increase its pH (discussed further below) prior to discharge to a water treatment facility.

Caustic soda (NaOH) can also be added to the treatment solution in the treatment line to neutralize the treatment solution prior to draining the treatment solution from the treatment line. Controlled amounts of caustic soda can be added via a caustic supply line 374 in fluid communication with the inlet flume through a caustic supply valve 376 (e.g., a digital-control valve). The pH monitor in the chemical panel can be used to control the amount of caustic soda added by monitoring the pH of the resulting fluid. The neutralization process can be controlled from a touch screen coupled with the PLC control panel 314. Initialization of the neutralization process starts a diaphragm pump that will pressure a common caustic supply manifold. The opening of the pneumatic drain valves for each treatment line can be inhibited until an acceptable pH level has been reached.

To fill the treatment line, chilled water can be added into the shaker return tank 310 via a wash tank fill valve 378 and into the chiller via a chiller fill valve 380. Un-chilled water can also be added into the treatment line via valves 368, 370, 372. Initially, a predetermined amount of treatment-solution concentrate can be added to the treatment line so as to produce a starting concentration of LA and PAA in the treatment solution. Such a starting concentration serves to remove chlorine from the water, thereby preventing the chlorine from coming into contact with the probes in the chemical panel, which may be damaged by contact with chlorine. Once the initial concentration is established, the chemical panel can be used to monitor the concentration of PAA in the treatment solution and the pH of the treatment solution and additional treatment-solution concentrate added to the treatment solution in a controlled fashion (e.g., stepwise, variable flow rate) until the desired treatment solution strength is reached and maintained.

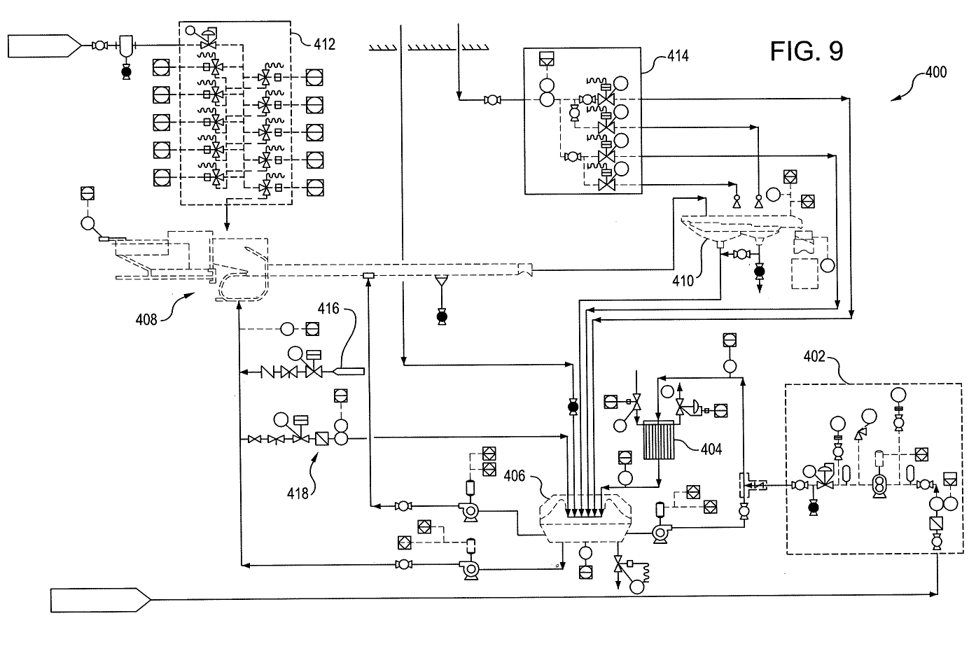

FIG. 9 shows a piping and installation diagram for another example treatment line 400 corresponding to the treatment line 28 of the treatment subsystem 16 of FIG. 1, in accordance with many embodiments. The treatment line 400 includes a chemical panel 402 that includes a metering pump to regulate the introduction of the treatment-solution concentrate into the treatment solution circulated within the treatment line, a chiller 404 to control the temperature of the treatment solution, a hydro-sieve and return tank 406 to remove particles from the treatment solution and to serve as a reservoir, a washing apparatus 408 that includes a flume in which the treatment solution is contacted with the produce, a dewatering shaker table 410 to rinse and dry the produce after the produce exits the washing apparatus, a pneumatic control panel 412 to provide control actuation airstreams supplied to various pneumatically controlled devices of the treatment line (e.g., pneumatically controlled valves), control valves 414 for the controlled introduction of chilled water into the treatment line, an inlet provision 416 for the introduction of a neutralizing agent (e.g., caustic soda) into the treatment line, and provisions 418 for obtaining a sample for pH measurement.

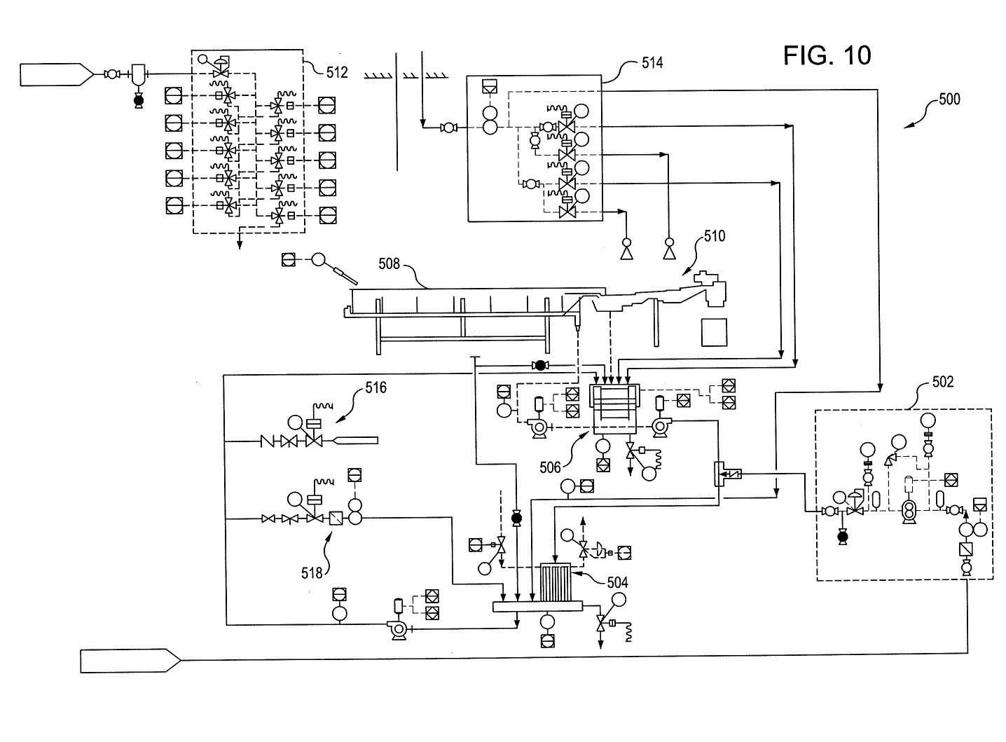

FIG. 10 shows a piping and installation diagram for another example treatment line 500 corresponding to the treatment line 28 of the treatment subsystem 16 of FIG. 1, in accordance with many embodiments. The treatment line 500 includes a chemical panel 502 that includes a metering pump to regulate the introduction of the treatment-solution concentrate into the treatment solution circulated within the treatment line, a chiller 504 and associated chiller tank to control the temperature of the treatment solution, a rotary filter and return tank 506 to filter particles out of the treatment solution and to serve as a reservoir, a wash tank 508 in which the treatment solution is contacted with the produce, an inclined dewatering belt 510 to rinse and dry the produce after the produce exits the wash tank, a pneumatic control panel 512 to provide control actuation airstreams supplied to various pneumatically controlled devices of the treatment line (e.g., pneumatically controlled valves), control valves 514 for the controlled introduction of chilled water into the treatment line, an inlet provision 516 for the introduction of a neutralizing agent (e.g., caustic soda) into the treatment line, and provisions 518 for obtaining a sample for pH measurement.

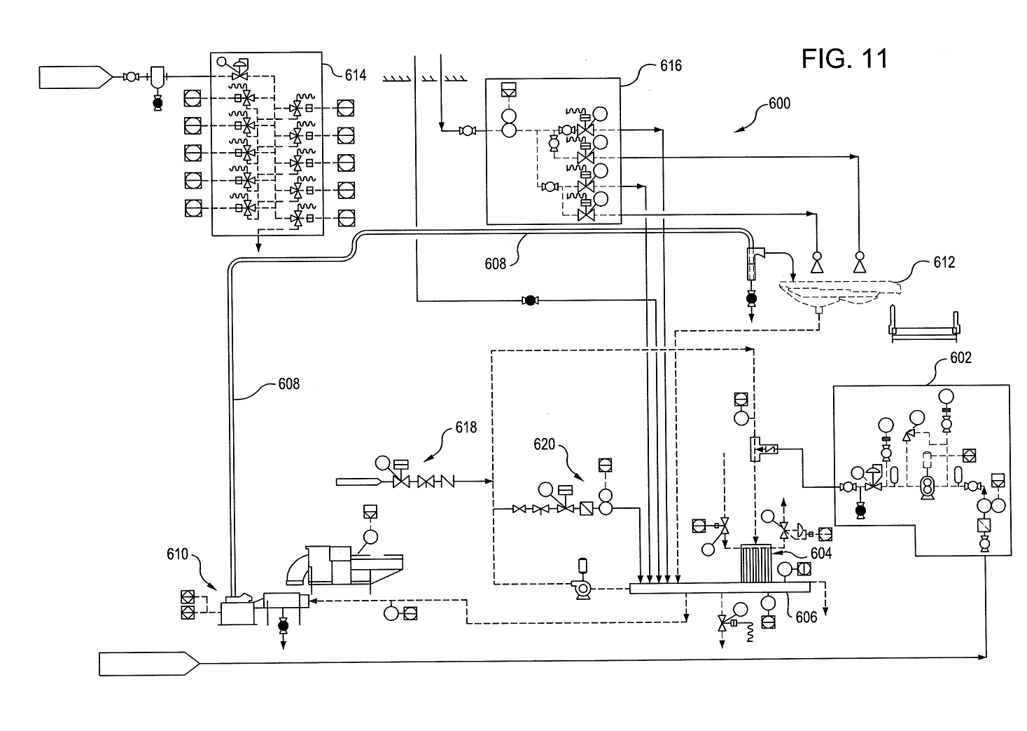

FIG. 11 shows a piping and installation diagram for another example treatment line 600 corresponding to the treatment line 28 of the treatment subsystem 16 of FIG. 1, in accordance with many embodiments. The treatment line 600 is a closed loop system in which the product is pumped through a pipe along with the treatment solution, thereby contacting the product with the treatment solution. The treatment line 600 includes a chemical panel 602 that includes a metering pump to regulate the introduction of the treatment-solution concentrate into the treatment solution circulated within the treatment line, a chiller 604 to control the temperature of the treatment solution, a return tank 606 to serve as a reservoir, a pipe 608 through which the product and the treatment solution are pumped, a flume pump 610 (e.g., a food pump) to pump the product and the treatment solution through the pipe, a shaker table 612 to rinse and dry the produce after the product exits the pipe, a pneumatic control panel 614 to provide control actuation airstreams supplied to various pneumatically controlled devices of the treatment line (e.g., pneumatically controlled valves), control valves 616 for the controlled introduction of chilled water into the treatment line, an inlet provision 618 for the introduction of a neutralizing agent (e.g., caustic soda) into the treatment line, and provisions 620 for obtaining a sample for pH measurement.

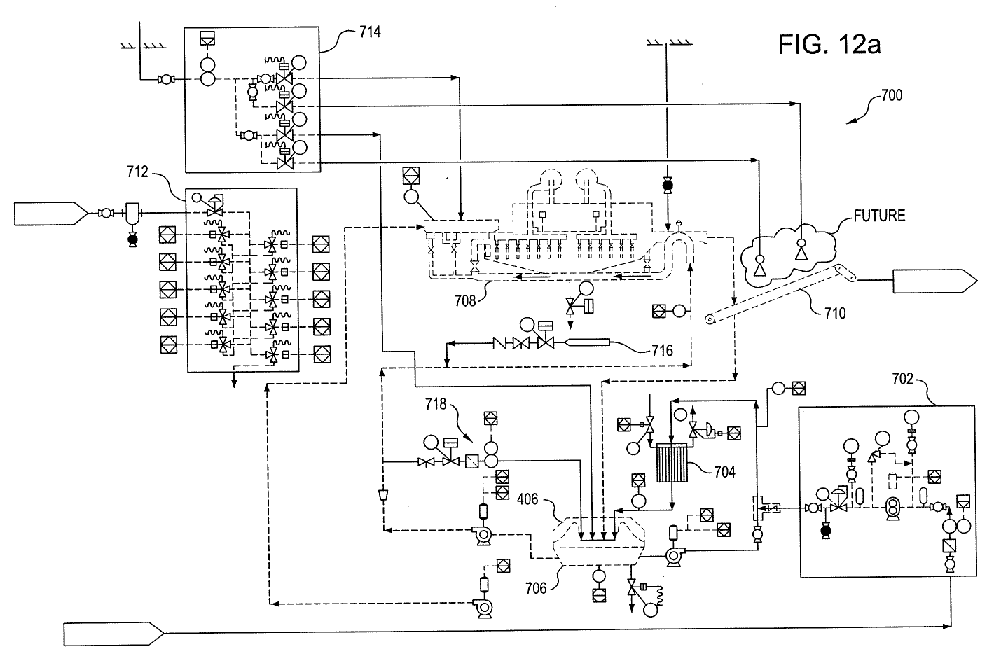

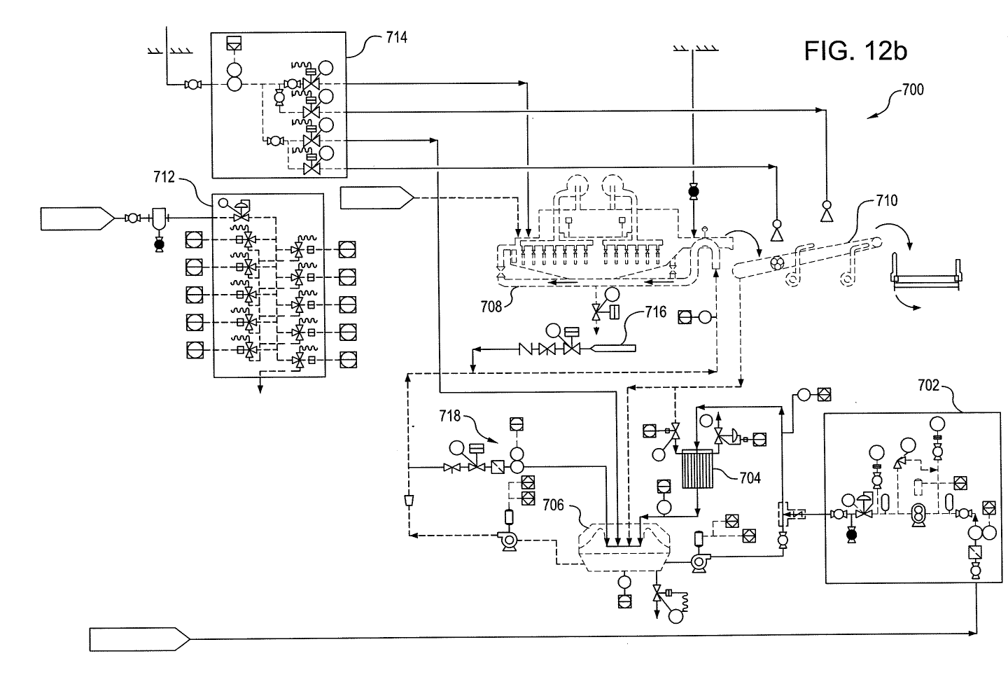

And FIGS. 12a and 12b show a piping and installation diagram for another example treatment line 700 corresponding to the treatment line 28 of the treatment subsystem 16 of FIG. 1, in accordance with many embodiments. The treatment line 700 provides for two-stage treatment of the product via two separate treatment line portions (one illustrated in FIG. 12a and the other illustrated in FIG. 12b) through which the product sequentially travels. Each of the two separate treatment line portions includes a chemical panel 702 that includes a metering pump to regulate the introduction of the treatment-solution concentrate into the treatment solution circulated within the treatment line, a chiller 704 to control the temperature of the treatment solution, a hydro-sieve and return tank 706 to remove particles from the treatment solution and to serve as a reservoir, a washing apparatus 708 having an articulating “flycatcher” mechanism to move the product through the washing apparatus thereby contacting the product with the treatment solution, a conveyor 710 to transport product upon exiting the washing apparatus, a pneumatic control panel 712 to provide control actuation airstreams supplied to various pneumatically controlled devices of the treatment line (e.g., pneumatically controlled valves), control valves 714 for the controlled introduction of chilled water into the treatment line, an inlet provision 716 for the introduction of a neutralizing agent (e.g., caustic soda) into the treatment line, and provisions 718 for obtaining a sample for pH measurement.

Purge Subsystem

In many embodiments, the sanitation system 10 is configured so that treatment-solution concentrate, treatment solution, and/or rinse water can be purged from the sanitation system 10. Such purging may be necessary on a regular basis. PAA, once mixed, typically has a limited shelf life (e.g., 24 hours or possibly longer when stored below 40 degrees Fahrenheit). As a result, any solution remaining in the sanitation system 10 can be purged on a regular basis to avoid the use of treatment-solution concentrate or treatment solution past its allowable shelf life. For example, any treatment-solution concentrate or treatment solution remaining in the sanitation system 10 can be drained at the end of operation if the time to the next period of operation exceeds 24 hours (e.g., last shift of week on Saturday).

The fluid purged from the sanitation system 10 can be transferred to the purge tank 88. The purge tank 88 can conveniently located (e.g., at the end of the delivery subsystem common manifold). Any treatment-solution concentrate remaining in the holding tank can be transferred directly to the purge tank. Treatment-solution concentrate in the common manifold can be drained to the purge tank, and any remaining treatment-solution concentrate in the common manifold can be purged using compressed air. Treatment solution and/or rinse water from one or more treatment lines can be neutralized as discussed above prior to discharge. Alternatively, the treatment solution and/or rinse water from one or more treatment lines can be transferred to the purge tank 88 for neutralization.

The fluid collected in the purge tank can be treated to neutralize it acidity prior to discharge to a waste water treatment facility. Many municipal waste water treatment facilities have a minimum pH level requirement (e.g., 5.0). The relatively large quantity of LA in the treatment solution (e.g., between 1800 ppm and 2200 ppm) causes the pH in the treatment solution to be about 2.8. The treatment-solution concentrate has an even lower pH. Neutralizing the fluid collected in the purge tank prior to discharge may be the lowest capital investment option by avoiding the installation of more expensive waste water treatment equipment. And it may avoid permitting and monitoring expenses that may arise with an external neutralization system and may eliminate potential corrosion issues with underground drain pipe.

Caustic soda (NaOH) can be added to the purge tank to neutralize the fluid collected in the purge tank. A pH sensor (e.g., a ProMinent pH sensor) can be used to determine the amount of caustic soda to add. The purge tank can be equipped with a mixer to mix the caustic soda and the collected fluid to ensure uniform treatment of the collected fluid prior to discharge from the purge tank.

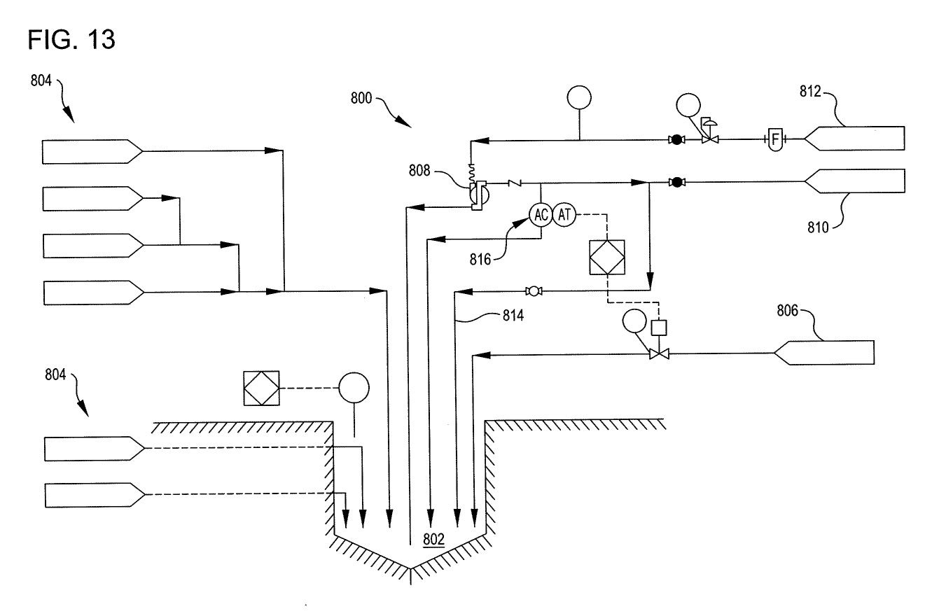

FIG. 13 illustrates a neutralization subsystem 800 operable to add a neutralizing agent to a treatment solution and/or a treatment-solution concentrate so as to form a neutralized solution suitable to be discharged to a waste water treatment facility, in accordance with many embodiments. The neutralization subsystem 800 includes a chemical room sump 802 in which the treatment solution and/or the treatment-solution concentrate can be mixed with the neutralizing agent (e.g., caustic soda), provisions 804 for the transfer of treatment solution and/or treatment-solution concentrate to the chemical room sump, provisions 806 for the introduction of the neutralizing agent into the chemical room sump, a discharge pump 808 to remove solution from the chemical room sump, an outlet 810 for the discharge of neutralized solution, a drive air line 812 to supply actuation air to the discharge pump, a return line 814 to circulate solution back to the chemical room sump during the neutralization process, and provisions 816 for monitoring the pH of the solution (e.g., before, during, and/or after the neutralization process).

Central Monitoring and Data Acquisition

The various subsystems of the sanitation system 10 (e.g., each individual treatment line, the treatment-solution concentrate preparation subsystem, the delivery subsystem) can be networked together for monitoring and data recording purposes. For example, the various subsystems can be networked to a dedicated central server and monitors in a quality assurance (QA) office and/or maintenance office via Ethernet protocol. Various operating parameters and/or operational modes can be displayed and intermittently logged. For example, for each treatment line, the operating parameters and operational modes displayed/logged can include PAA concentration measurements; pH measurements; acid feed valve open times; makeup water current flow rate; makeup water average flow rate; operating modes such as off, filling, initial dosing, running, washer idle, neutralizing, draining, and sanitizing; and acid feed valve accumulated time open by running hour. For the treatment-solution concentrate preparation subsystem, the monitored, displayed, and/or logged parameters can include, for example, concentration levels of LA and PAA in the treatment-solution concentrate; treatment-solution concentrate use rate and cumulative amount used; remaining volume of PAA and LA in their respective containers; current batch number; requested batch size; computed and measured water, LA, and PAA weights; and LA, pH, and PAA measured values. It will be recognized by a person skilled in the art that other operating parameters and operational modes, from any part of the sanitation system 10 can also be monitored, displayed, and/or logged.

Exemplary LA and PAA Consumption Rates

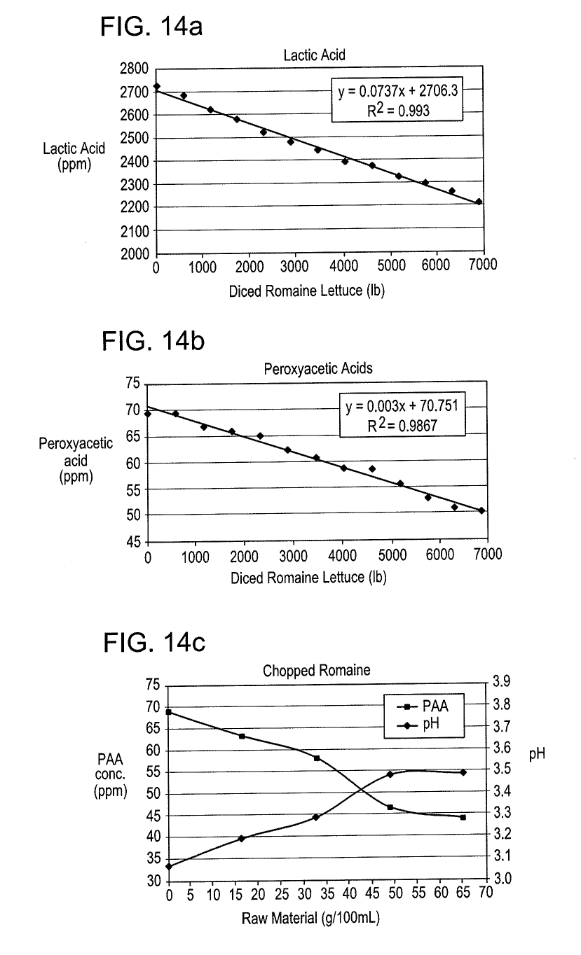

FIGS. 14a and 14b present some experimental consumption rates for LA and PAA in 600 gallons of treatment solution used to treat diced romaine lettuce in an experimental treatment line. The observed consumption rates calculate out to be 0.3701 lbs of LA and 0.0154 lbs of PAA per 1000 lbs of diced romaine lettuce.

FIG. 14c illustrates a consumption rate of PAA and an associated change in pH in the treatment solution during the treatment of chopped Romaine lettuce, in accordance with many embodiments. Accordingly, the pH of the treatment solution can be used as a proxy to monitor the consumption rate of the PAA and the LA in the treatment solution and therefore provide a parameter by which to control the introduction of treatment-solution concentrate into a treatment line to maintain suitable concentrations of PAA and LA in the treatment solution circulated in the treatment line.

Treatment-Solution Concentrate Transfer Rate

The treatment-solution concentrate can be transferred to a treatment line at a suitable rate to maintain suitable concentrations of the treatment acids in the treatment solution. For example, the rate by which the treatment-solution concentrate is transferred to the treatment line can be set based on a produce item type treated via the treatment line, a rate by which the produce item is treated via the treatment line, and a rate of rinse water employed during the treating of the produce item. For example, data for a particular produce item type, such as the data for romaine lettuce shown in FIGS. 14a, 14b, and 14c, can be used to preset the rate by which the treatment-solution concentrate is transferred to the treatment line.

The rate by which the treatment-solution concentrate is transferred to the treatment line can also be adjusted in response to a measured treatment acid concentration in the treatment solution, for example, in response to a measured concentration of PAA and/or LA in the treatment solution where the first treatment acid includes LA and the second treatment acid includes PAA. The transfer rate can be fine-tuned based on ongoing measurements of treatment acid concentrations. Accordingly, by introducing the treatment-solution concentrate into the treatment line at a rate substantially corresponding to the rate by which the treatment acids are depleted, more consistent concentrations of the treatment acids in the treatment solutions can be produced. The more consistent concentrations may enable the use of a electronic concentration measurements device (e.g., a PAA measurement device, a pH measurement device), which in some instances may have a slower reaction rate, but a reaction rate that is still sufficient given slower change rates of the acid concentrations in the treatment solution produced by transferring the treatment-solution concentrate into the treatment line at a suitable rate given the produce item type, the rate of treatment, and the rate that rinse water is employed.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims. For example, the methods, systems, and apparatus disclosed herein are flexible enough to allow for various types of produce to be treated via treatment solutions having suitable treatment acid concentrations.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method for treating a produce item, the method comprising:
measuring an amount of water;
measuring an amount of a first treatment acid;
measuring an amount of a second treatment acid;
mixing the measured amounts of the water and the first and second treatment acids to form a treatment-solution concentrate;
diluting a quantity of the treatment-solution concentrate to form a treatment solution; and
contacting an exterior surface of the produce item with a quantity of the treatment solution.

2. The method of claim 1, wherein the mixing the measured amounts is accomplished via a mixing tank.

3. The method of claim 2, further comprising transferring a quantity of the treatment-solution concentrate from the mixing tank to a holding tank.

4. The method of claim 3, further comprising circulating a quantity of the treatment-solution concentrate from the holding tank through a re-circulating loop and back to the holding tank.

5. The method of claim 4, wherein the quantity of the treatment-solution concentrate that is diluted to form the treatment solution is extracted from the re-circulating loop.

6. The method of claim 2, wherein each of the measured amounts is determined by weighing the mixing tank and contents of the mixing tank prior to adding the measured amount and at least one of during or after the addition of the measured amount to the mixing tank.

7. The method of claim 1, further comprising analyzing a sample of the treatment-solution concentrate to determine a concentration of the first treatment acid in the treatment-solution concentrate.

8. The method of claim 7, further comprising analyzing a sample of the treatment-solution concentrate to determine a concentration of the second treatment acid in the treatment-solution concentrate.

9. The method of claim 3, further comprising transferring a quantity of the treatment-solution concentrate from the holding tank to a treatment apparatus where the diluting a quantity of the treatment-solution concentrate to form a treatment solution and the contacting an exterior surface of the produce item with a quantity of the treatment solution is accomplished.

10. The method of claim 9, wherein said transferring a quantity of the treatment-solution concentrate includes transferring the treatment-solution concentrate to the treatment apparatus at a rate selected in response to a produce item type treated via the treatment apparatus, a rate by which the produce item is treated via the treatment apparatus, and a rate of rinse water employed during the treating of the produce item.

11. The method of claim 10, wherein the second treatment acid comprises peroxyacetic acid (PAA).

12. The method of claim 11, further comprising:
analyzing a sample of the treatment solution to determine a concentration of PAA in the treatment solution; and
adjusting the rate by which the treatment-solution concentrate is transferred to the treatment apparatus in response to the determined concentration of PAA in the treatment solution.

13. The method of claim 12, wherein the concentration of PAA in the treatment solution is determined by using a PAA measurement device.

14. The method of claim 10, wherein the first treatment acid comprises lactic acid (LA).

15. The method of claim 14, further comprising:
analyzing a sample of the treatment solution to determine a concentration of LA in the treatment solution; and
adjusting the rate by which the treatment-solution concentrate is transferred to the treatment apparatus in response to the determined concentration of LA in the treatment solution.

16. The method of claim 9, further comprising:
adding a neutralizing agent to a quantity of the treatment solution in the treatment apparatus to form a neutralized treatment solution having a pH higher than the treatment solution prior to neutralization; and
discharging the neutralized treatment solution from the treatment apparatus.

17. The method of claim 9, further comprising:
transferring a quantity of the treatment-solution concentrate to a purge tank;
adding a neutralizing agent to the purge tank to form a neutralized treatment-solution concentrate having a pH higher than the quantity of the treatment-solution concentrate prior to neutralization; and
discharging the neutralized treatment-solution concentrate from the purge tank.

18. The method of claim 1, wherein the first treatment acid comprises lactic acid.

19. The method of claim 18, wherein the second treatment acid comprises peroxyacetic acid.

20. The method of claim 19, wherein:
the concentration of the lactic acid in the treatment solution is between 850 parts per million (ppm) and 10,000 ppm; and
the concentration of the peroxyacetic acid in the treatment solution is between 10 ppm and 80 ppm.

21. The method of claim 20, wherein:
the concentration of the lactic acid in the treatment solution is between 1300 ppm and 5600 ppm; and
the concentration of the peroxyacetic acid in the treatment solution is between 65 ppm and 75 ppm.

22. The method of claim 1, wherein the second treatment acid comprises peroxyacetic acid (PAA).

23. The method of claim 22, further comprising analyzing a sample of the treatment-solution concentrate by using a PAA measurement device to determine a concentration of the PAA in the treatment-solution concentrate.

24. The method of claim 23, further comprising adding at least one of water or PAA to the treatment-solution concentrate in response to the determined concentration of the PAA in the treatment-solution concentrate to adjust the concentration of the PAA in the treatment-solution concentrate.

25. The method of claim 22, further comprising analyzing a sample of the treatment solution by using a PAA measurement device to determine a concentration of the PAA in the treatment solution.

26. The method of claim 25, further comprising adding at least one of water or PAA to the treatment solution in response to the determined concentration of the PAA in the treatment solution to adjust the concentration of the PAA in the treatment solution.

27. A system for treating a produce item, the system comprising:
a mixing subsystem to prepare a treatment-solution concentrate that includes a measured amount of water, a measured amount of a first treatment acid, and a measured amount of a second treatment acid; and
a treatment subsystem in controlled fluid communication with the mixing subsystem and configured to dilute a quantity of the treatment-solution concentrate received from the mixing subsystem to form a treatment solution and contact an exterior surface of the produce item with a quantity of the treatment solution.

28. The system of claim 27, wherein the mixing subsystem comprises a mixing tank to mix the measured amount of water, the measured amount of the first treatment acid, and the measured amount of the second treatment acid.

29. The system of claim 28, further comprising a holding tank in controlled fluid communication with the mixing tank to receive a quantity of the treatment-solution concentrate from the mixing tank.

30. The system of claim 29, further comprising a re-circulating loop through which a quantity of the treatment-solution concentrate received from the holding tank is circulated back to the holding tank.

31. The system of claim 30, wherein the treatment subsystem receives the quantity of the treatment-solution concentrate that is diluted via an outlet in the re-circulating loop.

32. The system of claim 28, further comprising at least one weight measuring devices to determine the measured amount of the water, the measured amount of the first treatment acid, and the measured amount of the second treatment acid,
wherein each of the measured amounts is determined by weighing the mixing tank and contents of the mixing tank prior to adding the measured amount and at least one of during or after the addition of the measured amount to the mixing tank.

33. The system of claim 27, further comprising a neutralization subsystem configured to add a neutralizing agent to at least one of a quantity of the treatment solution or a quantity of the treatment-solution concentrate to form a neutralized solution and discharge the neutralized solution from the neutralization subsystem.

34. The system of claim 33, wherein the neutralization subsystem comprises a purge tank to receive at least one of the quantity of the treatment solution or the quantity of the treatment-solution concentrate and to receive the added neutralizing agent.

35. The system of claim 27, wherein the first treatment acid comprises lactic acid (LA).

36. The system of claim 35, wherein the second treatment acid comprises peroxyacetic acid (PAA).

37. The system of claim 36, further comprising a PAA measurement device to determine a concentration of the PAA in at least one of the treatment-solution concentrate or the treatment solution.

38. The system of claim 36, wherein:
the concentration of the lactic acid in the treatment solution is between 840 parts per million (ppm) and 10,000 ppm; and
the concentration of the peroxyacetic acid in the treatment solution is between 10 ppm and 80 ppm.

39. The system of claim 38, wherein:
the concentration of the lactic acid in the treatment solution is between 1300 ppm and 5600 ppm; and
the concentration of the peroxyacetic acid in the treatment solution is between 65 ppm and 75 ppm.

40. The system of claim 27, wherein the second treatment acid comprises peroxyacetic acid.

41. The system of claim 27, wherein the treatment-solution concentrate is transferred to the treatment subsystem at a rate selected in response to a produce item type treated via the treatment subsystem, a rate by which the produce item is treated via the treatment subsystem, and a rate of rinse water employed during the treating of the produce item.

42. The system of claim 41, wherein the second treatment acid comprises peroxyacetic acid (PAA).

43. The system of claim 42, further comprising a PAA measurement device to measure a concentration of PAA in the treatment solution, and wherein the rate by which the treatment-solution concentrate is transferred to the treatment subsystem is adjusted in response to the measured concentration of PAA in the treatment solution.

44. The system of claim 41, wherein:
the first treatment acid comprises lactic acid (LA);
a sample of the treatment solution is analyzed to determine a concentration of LA in the treatment solution; and
the rate by which the treatment-solution concentrate is transferred to the treatment subsystem is adjusted in response to the measured concentration of LA in the treatment solution.

45. An apparatus for treating a produce item, the apparatus comprising:
a fluid circuit circulating a treatment solution;
a washing station contacting an exterior surface of the produce item with the treatment solution;
a first controllable inlet device to control transfer of a treatment-solution concentrate into the circulating treatment solution, the treatment-solution concentrate comprising a first treatment acid and a second treatment acid; and
a second controllable inlet device to control the transfer of water into the circulating treatment solution, the first and second inlet devices controlled to regulate the concentration of the treatment-solution concentrate in the circulating treatment solution.

46. The apparatus of claim 45, wherein the first treatment acid comprises lactic acid.

47. The apparatus of claim 46, wherein the second treatment acid comprises peroxyacetic acid.

48. The apparatus of claim 47, wherein the first and second inlet devices regulate the concentration of the treatment-solution concentrate in the circulating treatment solution so that the concentration of the lactic acid in the treatment solution is between 840 parts per million (ppm) and 10,000 ppm and the concentration of the peroxyacetic acid in the treatment solution is between 10 ppm and 80 ppm.

49. The apparatus of claim 48, wherein the first and second inlet devices regulate the concentration of the treatment-solution concentrate in the circulating treatment solution so that the concentration of the lactic acid in the treatment solution is between 1300 ppm and 5600 ppm, and the concentration of the peroxyacetic acid in the treatment solution is between 65 ppm and 75 ppm.

50. The apparatus of claim 45, wherein each of the first and second inlet devices includes at least one of a controllable valve or a metering pump.

51. The apparatus of claim 45, wherein the first inlet device is controlled to transfer the treatment-solution concentrate into the circulating treatment solution at a rate selected in response to a produce item type treated via the treatment apparatus, a rate by which the produce item is treated via the treatment apparatus, and a rate of rinse water employed during the treating of the produce item.
